(19) United States
(12) Patent Application Publication
(10) Pub. No.: US 2024/0075855 A1
(43) Pub. Date: Mar. 7, 2024

(54) CHILD SAFETY SEAT FOR SAFETY WARNING SYSTEM AND CHILD SAFETY SEAT

(71) Applicant: WONDERLAND SWITZERLAND AG, Steinhausen (CH)

(72) Inventors: Zhengwen GUO, Steinhausen (CH); Manqun CHENG, Steinhausen (CH); Zujian LIU, Steinhausen (CH)

(21) Appl. No.: 18/263,064

(22) PCT Filed: Jan. 28, 2022
(86) PCT No.: PCT/EP2022/052034

§ 371 Date: Jul. 26, 2023

(30) Foreign Application Priority Data
Jan. 28, 2021 (CN) 202110118583.8
Mar. 16, 2021 (CN) 202110282116.9

(51) Int. Cl. B60N 2/26; B60N 2/28

(52) U.S. Cl. CPC B60N 2/272; B60N 2/2821; B60N 2/2887

(57) ABSTRACT

The present disclosure discloses a safety warning system for a child safety seat including a first detection device sending a first detection signal when detecting that the top tether is tensioned, a second detection device sending a second detection signal when detecting that the ISOFIX connector is installed in place, a third detection device sending a third detection signal when detecting that the buckle is buckled, and a transfer control device receiving first, second and third detection signals. When at least one of first, second and third detection signals is not received, the transfer control device sends an alarm signal to remind the user whether the top tether is installed or buckled, ISOFIX connector and buckle are correct, ensuring the safety and comfort of the child, and improving the installation efficiency of child safety seat. The present disclosure also provides a child safety seat.

### CROSS-REFERENCE TO RELATED APPLICATIONS

This application is a 371 U.S. National Phase of International Patent Application No. PCT/EP2022/052034, filed on Jan. 28, 2022, which is based on and claims priority to Chinese Application No. 202110118583.8, filed on Jan. 28, 2021 and Chinese Application No. 202110282116.9, filed on Mar. 16, 2021, which are incorporated herein by reference in their entirety.

### TECHNICAL FIELD

The present disclosure relates to the technical field of child carriers and in particular to a safety warning system for a child safety seat and a child safety seat.

### BACKGROUND

Various types of child carriers (such as a stroller, a baby cradle, a safety seat, a baby holding belt, etc.) are widely applied in families having babies. During installation and use of the child carrier, not only the child carrier itself needs to be installed in place, but also a restraint system for retaining a child on the child carrier needs be fastened in place, so as to achieve a protection effect. However, in practical use, an improper installation may often occurs and may not be found timely due to lack of experience or negligence, or a situation that the child is restrained on the carrier for a long time may also occur due to negligence of his\her caregiver, reducing the safety of a child on the carrier. Moreover, there are many kinds of installation structures and restraint systems on the child carrier, and it takes much time to manually confirm them one by one after installation, which is not conducive to improving the installation efficiency.

If it is possible to combine conditions (such as use, connection, or the like) of the child carrier with an external control device or a mobile device to control and monitor these conditions of the child carrier through the external control device or the mobile device, the safety and comfort during use of the child carrier would be maximized.

Therefore, it is necessary to provide a safety warning system for a child safety seat to address the above problems.

In addition, the existing child safety seat usually includes a base and a seat arranged on the base, ISOFIX interfaces are arranged at a side of the base, and a support leg arranged in front of the base. The ISOFIX interfaces of the child safety seat are correspondingly connected to corresponding installation positions in the vehicle, and the support leg is supported on the floor in front of the vehicle seat, so that the child safety seat may be fixed. The ISOFIX interfaces are fixed on both sides of the base, and the support leg is fixed in front of the child safety seat. Through these three fixing points, the child safety seat may be firmly fixed on the vehicle seat, and will not be turned over when it is impacted.

The commercially available child safety seats installed by the ISOFIX interfaces and a support leg is convenient and quick to assemble, however, if the user fails to assemble the child safety seat in place or improperly assemble the child safety seat, or omits to assemble a part into the seat during assembly, the safety of the child seating on the seat will be greatly reduced.

Therefore, it is necessary to develop a child safety seat that can reliably prompt whether it is installed properly.

### SUMMARY

An objective of the present disclosure is to provide a safety warning system for a child safety seat to improve safety, comfort and installation efficiency.

An objective of the present disclosure is to provide a child safety seat with a reliable structure, which can prompt whether the child safety seat is fixed in place.

Another objective of present disclosure is to provide a child safety seat having an alarm device triggered by a mechanical structure.

Another objective of present disclosure is to provide a child safety seat accurately reminding a specific location that is not installed in place.

Another objective of the present disclosure is to provide a child safety seat that can alleviate or eliminate at least one of the above-mentioned defects.

In order to achieve the above objectives, the present disclosure provides a safety warning system for a child safety seat which has a top tether, an International Standards Organization FIX (ISOFIX) connector and a buckle, and selectively gives an alarm according to an alarm signal that is received. A first aspect of the present disclosure provides a safety warning system for a child safety seat. The safety warning system for the child safety seat includes a first detection device, a second detection device, a third detection device and a transfer control device. The first detection device is configured to detect whether the top tether is in a tensioned state, and send out a first detection signal when detecting that the top tether is tensioned. The second detection device is configured to detect whether the ISOFIX connector is installed in place, and send out a second detection signal when detecting that the ISOFIX connector is installed in place. The third detection device is configured to detect whether the buckle is buckled, and send out a third detection signal when detecting that the buckle is buckled. The transfer control device is configured to receive the first detection signal, the second detection signal and the third detection signal, so that the alarm device sends out an alarm signal when at least one of the first detection signal, the second detection signal and the third detection signal is not received by the transfer control device.

In an embodiment, the first detection device includes a first detector provided on a moving path of the top tether for detecting whether the top tether is tensioned.

In an embodiment, the second detection device includes a second detector provided on the ISOFIX connector for detecting whether the ISOFIX connector is installed in place.

In an embodiment, the third detection device includes a third detector provided on the buckling path of the buckle for detecting whether the buckle is buckled.

In an embodiment, the transfer control device is electrically connected with the first detection device, the second detection device and the third detection device by a wired or wireless mode, respectively.

In an embodiment, the alarm device is electrically connected with the transfer control device.

In an embodiment, the transfer control device and the alarm device are electrically connected with each other by a wired or wireless mode.

In an embodiment, the transfer control device is also communicatively connectable with a mobile terminal or a vehicle control system to send the alarm signal to the mobile terminal or the vehicle control system.

In an embodiment, the transfer control device, the first detection device, the second detection device and the third detection device are provided independently from one another.

In an embodiment, the transfer control device is provided in the child safety seat or a vehicle.

In an embodiment, the first detection device includes a first detector configured to detect whether the top tether is tensioned, and a first wireless module configured to wirelessly connect with the transfer control device and send the first detection signal to the transfer control device.

In an embodiment, the second detection device includes a second detector configured to detect whether the ISOFIX connector is installed in place, and a second wireless module configured to wirelessly connect with the transfer control device and send the second detection signal to the transfer control device.

In an embodiment, the third detection device includes a third detector configured to detect whether the buckle is buckled and a third wireless module configured to wirelessly connect with the transfer control device and send the third detection signal to the transfer control device.

In an embodiment, the relay control device includes a wireless communication module configured to wirelessly connect with the first wireless module, the second wireless module and the third wireless module.

In an embodiment, the wireless communication module, the first wireless module, the second wireless module and the third wireless module are Bluetooth modules or Wi-Fi modules.

In an embodiment, the first detection device includes a first detection circuit board and a first detector electrically connected to the first detection circuit board; the second detection device includes a second detection circuit board and a second detector electrically connected to the second detection circuit board; the third detection device includes a third detection circuit board and a third detector electrically connected to the third detection circuit board; and the first detection circuit board, the second detection circuit board and the third detection circuit board are respectively electrically connected to the transfer control device through wires.

In an embodiment, the transfer control device is integrated with the first detection device, the second detection device and the third detection device; the first detection device includes a first detector provided on the moving path of the top tether for detecting whether the top tether is tensioned, and the first detector is electrically connected to the first detection device through wires; the second detection device includes a second detector provided on the ISOFIX connector for detecting whether the ISOFIX connector is installed in place, and the second detector is electrically connected to the second detection device through wires; the third detection device includes a third detector provided on the buckling path of the buckle for detecting whether the buckle is buckled, and the third detector is electrically connected to the third detection device through wires.

In an embodiment, when the top tether is tensioned, the top tether acts on the first detector, so that the first detection device generates and sends out the first detection signal.

In an embodiment, the first detection device also includes a first trigger movably provided and connected to the top tether, and driven by the top tether to move during the tension process of the top tether to act on the first detector.

In an embodiment, the first detection device also includes an elastic member abutting against the first trigger. When the top tether is not tensioned, the elastic force of the elastic member resets the first trigger to release the first detector.

In an embodiment, the first detection device also includes a traction member, both ends of the traction member are respectively connected to the top tether and the first trigger, and the top tether pulls the first trigger to move via the traction member.

In an embodiment, the first detection device also includes a slider slidably provided and connected with the top tether and the traction member respectively. When the top tether is tensioned by an external force, the slider is driven to slide and pulls the first trigger to move via the traction member.

In an embodiment, the second detection device also includes a second trigger movably provided and connected to the ISOFIX connector. During the installation process of the ISOFIX connector, the second trigger is driven to move to act on the second detection device. When the ISOFIX connector is installed in place, the second detection device generates and sends out the second detection signal.

In an embodiment, the third detector is installed in a male buckle or a female buckle of the buckle. When the male buckle is buckled with the female buckle, the male buckle or the female buckle acts on the third detector, and the third detection device generates and sends out the third detection signal.

In an embodiment, a through hole is provided on one of the male buckle and the female buckle, the third detector is disposed inside the male buckle or the female buckle and protrudes through the through hole on an insertion path between the male buckle and the female buckle, and the male buckle or female buckle acts on the third detector when the male buckle is buckled with the female buckle.

In an embodiment, each of the first detector, the second detector and the third detector may be any one of a mechanical switch, a contact sensor, a pressure sensor, an infrared sensor and a displacement sensor.

Compared with the related art, the safety warning system for the child safety seat of the present disclosure has a first detection device, a second detection device and a third detection device, which are respectively configured to detect whether the top tether is installed or buckled, the ISOFIX connector and the buckle, and send out the first detection signal, the second detection signal and the third detection signal. The alarm device sends out an alarm signal when at least one of the first, second and third detection signals is not received by the transfer control device, and then remind the user whether the top tether is installed or buckled, the ISOFIX connector and the buckle are correct, so as to ensure the safety and comfort of the child seating in the vehicle, and improve the installation efficiency of child safety seat.

A second aspect of the present disclosure provides a child safety seat adapted to be installed on a seat of a vehicle and including the safety warning system for the child safety seat as mentioned above.

In an embodiment, the child safety seat includes: a base having an anchoring portion connected to the seat of the vehicle; a seat portion arranged on the base; and a support leg arranged at a front of the base and extending from the base towards a floor of the vehicle. The alarm device includes a plurality of switches, and selectively giving an alarm in response to turning-off and turning-on of the plurality of switches. The support leg includes a first tube and a second tube sleeved with each other, and when the first tube is locked to the second tube, a pressure is applied to an end of the second tube to turn on one of the plurality of switches.

In an embodiment, the plurality of switches are three switches, and the alarm device is configured to: give an alarm when any one of the three switches is turned on and the three switches are not all turned on; and give no alarm when all the three switches are turned on or turned off.

In an embodiment, the anchoring portion includes two anchoring arms, a first switch in the three switches is turned on in response to the support leg abutting against the floor of the vehicle, and the second switch and the third switch in the three switches are turned on in response to a corresponding one of the two anchoring arms being anchored to a position of the seat of the vehicle, respectively.

In an embodiment, the support leg includes a display portion having three light emitting devices sequentially arranged along a transverse direction of the child safety seat, when the alarm device gives an alarm, an light emitting device in the middle in the three light emitting devices emits light in response to turning-on of the first switch, and light emitting devices on both sides in the three light emitting devices emit light in response to turning-on of the first switch and the second switch, respectively.

In an embodiment, a receiving member is arranged in the first tube, the receiving member is slidably arranged between the first tube and the second tube, and an end of the receiving member is provided with a trigger portion for turning-on one of the plurality of switches.

In an embodiment, the first tube is slidably sleeved on the second tube, and an engaging member is arranged in the second tube and is selectively locked to different positions of the receiving member.

In an embodiment, the support leg further includes a grounding portion at an end of the second tube for contacting the floor of the vehicle, the grounding portion includes pressing portions arranged at both sides, and the pressing portions are linked with the engaging member, so that when the pressing portions are pressed, the engaging portion is disengaged and unlocked with the receiving member, and when the pressing portions are not pressed, the engaging portion is locked with the receiving member.

In an embodiment, the second tube further includes a linkage, the pressing portions and the engaging portion are linked through the linkage, a first inclined surface is formed on the pressing portion, and a second inclined surface is formed on an end of the linkage, and movement of the pressing portions in a first direction enables the linkage to move in a second direction perpendicular to the first direction via cooperation of the first inclined surface and the second inclined surface.

In an embodiment, the engaging member is rotatably fixed in the second tube via a pivot shaft, a chute is formed on the other end of the linkage, the engaging member is coupled with the chute via an actuating shaft, the actuating shaft is movable in the chute, and movement of the linkage in the second direction enables the engaging member to rotate about the pivot shaft.

In an embodiment, an elongated slot extending in the second direction is formed on the linkage, a pin fixed in the second tube passes through the elongated slot, and a reset member is arranged between the linkage and the grounding portion to provide a thrust force.

In an embodiment, the receiving member is provided with a plurality of segment holes along a direction in which the first tube moves relative to the second tube, and the engaging member is locked to the receiving member by engaging with one of the plurality of segment holes.

The second aspect of the present disclosure has at least one of the followings advantages:

The child safety seat of the present disclosure can conveniently reminder that the child safety seat is not properly fixed, thereby improving the safety of the child safety seat, effectively avoiding a situation of assembly with missing parts or improper assembly by consumers, and better protecting the child siting in the seat. Furthermore, the child safety seat of the present disclosure can accurately indicate the specific connector that is not fixed in place. The structure design of the support leg of the child safety seat of the present disclosure is reasonable, and the alarm device is triggered by a reliable mechanical structure, thereby more effectively determining whether the child safety seat is properly installed. In addition, the child safety seat of the present disclosure is easy to adjust, stable and durable.

### BRIEF DESCRIPTION OF THE DRAWINGS

FIG. 1 is a structural schematic view of a child safety seat in a first embodiment of a first aspect of the present disclosure.

FIG. 2 is a structural schematic view of a base in FIG. 1 with an upper cover thereof removed.

FIG. 3 is a back structural schematic view of the child safety seat in FIG. 1.

FIG. 4 is a structural schematic view of FIG. 3 with a support removed.

FIG. 5 is an enlarged schematic view of a part A in FIG. 4.

FIG. 6 is another back structural schematic view of the child safety seat in FIG. 1.

FIG. 7 is a structural schematic view of FIG. 1 with a support removed.

FIG. 8 is an enlarged schematic view of a part B in FIG. 7.

FIG. 9 is a structural schematic view of the base in FIG. 2 from another angle.

FIG. 10 is an exploded view of a buckle in FIG. 1.

FIG. 11 is a structural schematic view of a male buckle in FIG. 10.

FIG. 12 is a structural schematic view of a female buckle in FIG. 10.

FIG. 13 is a circuit schematic diagram of the safety warning system for the child safety seat in the first embodiment of the first aspect of the present disclosure.

FIG. 14 is a schematic principle block diagram of the safety warning system for the child safety seat in the first embodiment of the first aspect of the present disclosure.

FIG. 15 is a back structural schematic view of a child safety seat in a second embodiment of the first aspect of the present disclosure.

FIG. 16 is a structural schematic view of FIG. 15 with a support removed.

FIG. 17 is an enlarged schematic view of a part C in FIG. 16.

FIG. 18 is an enlarged schematic view of a part D in FIG. 16.

FIG. 19 is a circuit schematic diagram of the safety warning system for the child safety seat in the second embodiment of the first aspect of the present disclosure.

FIG. 20 is a back structural schematic view of a child safety seat in a third embodiment of the first aspect of the present disclosure with a support removed.

FIG. 21 is another back structural schematic view of the child safety seat in the third embodiment of the first aspect of the present disclosure with the support removed.

FIG. 22 is a structural schematic view of a base in FIG. 20 from another angle.

FIG. 23 is an exploded view of a buckle in the third embodiment of the first aspect of the present disclosure.

FIG. 24 is a circuit schematic diagram of a safety warning system for the child safety seat in the third embodiment of the first aspect of the present disclosure.

FIG. 25 is a schematic principle block diagram of a safety warning system for a child safety seat in a fourth embodiment of the first aspect of the present disclosure.

FIG. 26 is a perspective view of a child safety seat of a second aspect of the present disclosure, with a seat portion removed.

FIG. 27 is a front sectional view of a support leg of the child safety seat of the second aspect of the present disclosure.

FIG. 28 is a side sectional view of the support leg of the child safety seat of the second aspect of the present disclosure at an extended length.

FIG. 29 is a side sectional view of the support leg of the child safety seat of the second aspect of the present disclosure at another extended length, in which a switch is in a turn-off state.

FIG. 30 is a side sectional view of the support leg of the child safety seat of the second aspect of the present disclosure at another extended length, in which the switch is in a turn-on state.

FIG. 31 is a partially sectional perspective view of some components of the child safety seat of the second aspect of the present disclosure.

FIG. 32 is another partially sectional perspective view of some components of the child safety seat of the second aspect of the present disclosure.

FIG. 33 is a schematic view of an alarm device of the child safety seat of the second aspect of the present disclosure.

FIG. 34 is a schematic view of a cooperating relationship between a linkage and an engaging member of the child safety seat of the second aspect of the present disclosure.

FIG. 35 is another schematic view of the cooperating relationship between the linkage and the engaging member of the child safety seat of the second aspect of the present disclosure.

### DETAILED DESCRIPTION

The aspects and their embodiments of the present disclosure will now be described with reference to the accompanying drawings, in which the same reference numbers represent the same elements. A safety warning system 100 for a child safety seat provided by the present disclosure is mainly applicable to a child safety seat 200, which is not limited thereto, and may also be used in other child carriers.

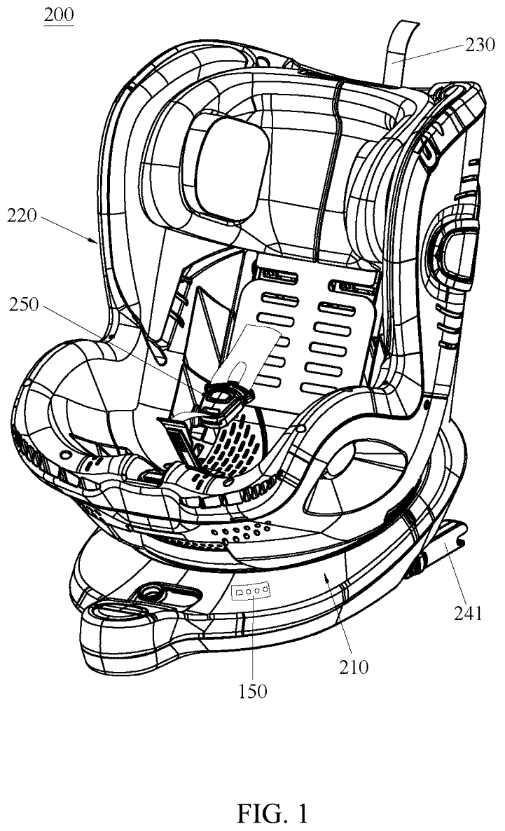

Firstly, with reference to FIGS. 1-4, the child safety seat 200 according to a first aspect of the present disclosure mainly includes a base 210 and a seat body 220 installed on the base 210. In addition, a top tether 230 is disposed on the seat body 220, and a rear end of the base 210 is provided with two ISOFIX connectors 240. The top tether 230 and the two ISOFIX connectors 240 are configured to connect with a vehicle to fix the child safety seat 200, so as to form a three-point connection to meet a safety standard. Referring again to FIG. 1, the seat body 220 is also provided with a safety belt system for restraining the child. The safety belt system in FIG. 1 is not fully shown, but the safety belt system is provided in a conventional mode. A buckle 250 is provided on the safety belt system. The buckle 250 is buckled so that the safety belt system may fix the child seating on the seat body 220.

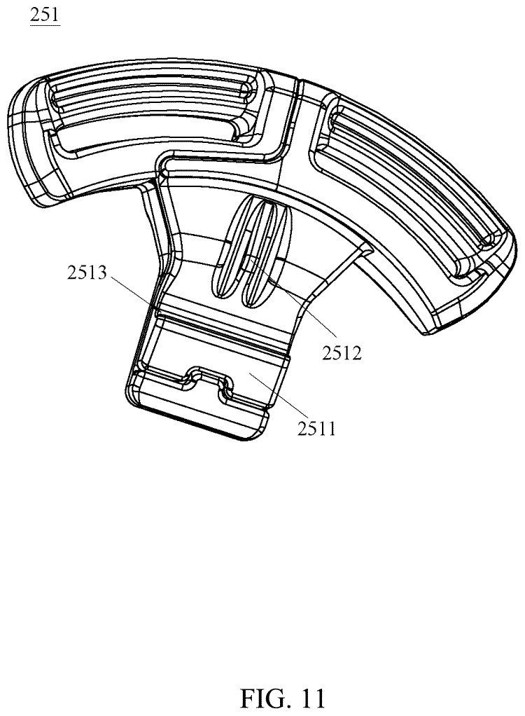

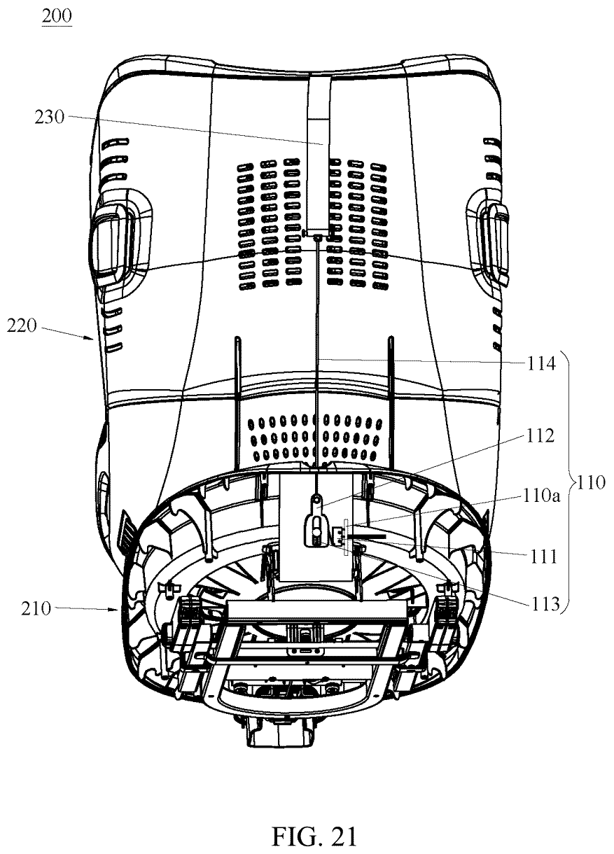

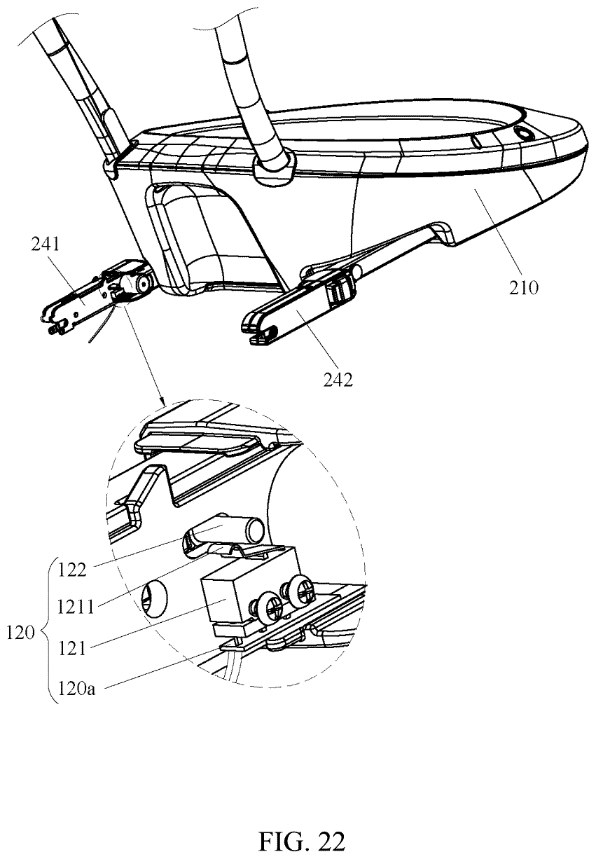

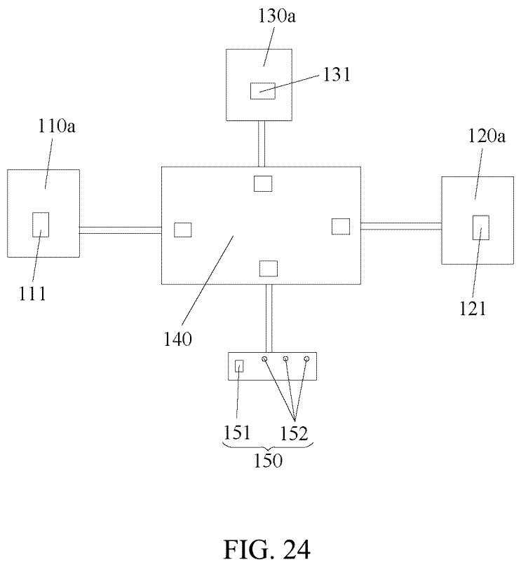

As shown below in conjunction with FIGS. 1-25, the safety warning system 100 for the child safety seat of the present disclosure includes a first detection device 110, a second detection device 120, a third detection device 130, a transfer control device 140 and an alarm device 150. The first detection device 110 is provided on a moving path of the top tether 230 for detecting whether the top tether 230 is in a tensioned state and sending out a first detection signal when the top tether 230 is tensioned; the second detection device 120 is provided in the ISOFIX connector 240 for detecting whether the ISOFIX connector 240 is installed in place and sending out a second detection signal when the ISOFIX connector 240 is installed in place; and the third detection device 130 is provided in the buckle 250 for detecting whether the buckle 250 is buckled and sending out a third detection signal when the buckle 250 is buckled. The transfer control device 140 is electrically connected with the first detection device 110, the second detection device 120, the third detection device 130 and the alarm device 150, respectively, for receiving the first detection signal, the second detection signal and the third detection signal, and sending out an alarm signal when at least one of the first detection signal, the second detection signal and the third detection signal is not received; the alarm device 150 is configured to receive the alarm signal and give an alarm according to the alarm signal.

It should be noted that the number of any of the first detection device 110, the second detection device 120 and the third detection device 130 may be flexibly provided as required. For example, at least one first detection device 110 may be provided according to the disposing mode of the top tether 230. For the ISOFIX connector 240, a preferred mode is to provide the second detection device 120 in each of the ISOFIX connectors 240, which is not limited thereto. The third detection device 130 is specifically selected according to the number of the buckle 250.

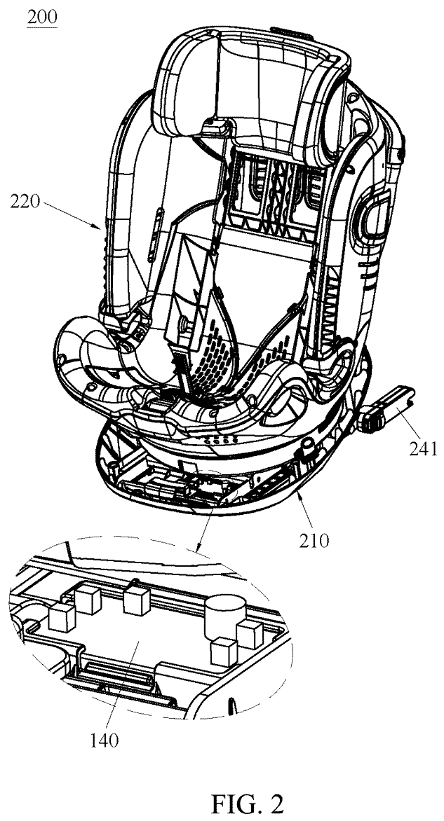

With continuing reference to FIGS. 1-2, in the present disclosure, the transfer control device 140 is preferably installed inside the base 210, however, it is not limited thereto, and may be installed at any position of the child safety seat 200 that is convenient to install. In addition, for the independently disposed transfer control device 140, it may also be installed on the vehicle (as described in detail below).

Continuing in conjunction with FIGS. 1-2, 14 and 25, the transfer control device 140 may also be communicatively connected to a mobile terminal 300 or a vehicle control system (not shown) to send the alarm signal to the mobile terminal 300 or the vehicle control system, and then display alarm information via the mobile terminal 300 or the vehicle control system, thus more conveniently informing or prompting the user.

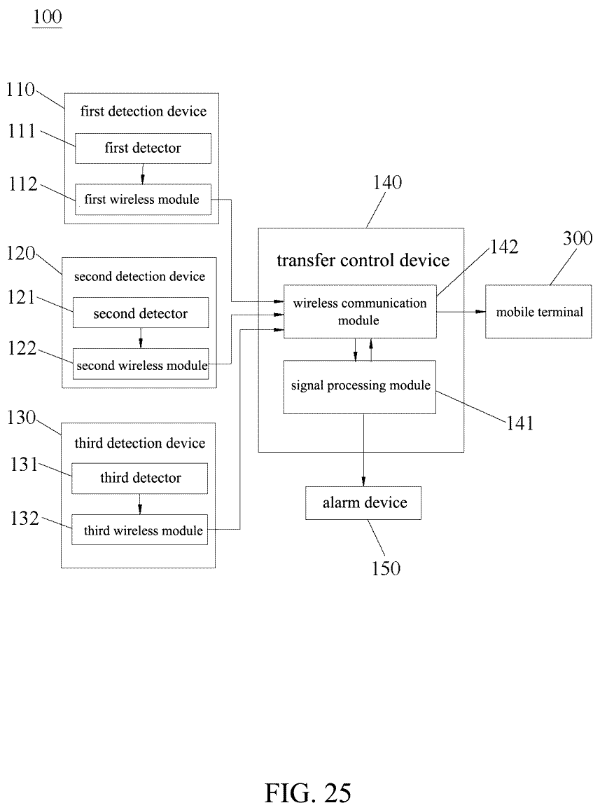

With reference to FIGS. 14 and 25, the transfer control device 140 includes a signal processing module 141 and a wireless communication module 142. The wireless communication module 142 is configured to communicatively connected to the mobile terminal 300 or the vehicle control system. The signal processing module 141 is configured to obtain the first detection signal, the second detection signal and the third detection signal and process the signals, and generate the alarm signal when at least one of the first detection signal, the second detection signal and the third detection signal is not received. At this time, the signal processing module 141 may directly control the alarm device 150 to give an alarm according to the alarm signal, or may send the alarm signal to the mobile terminal 300 or the vehicle control system through the wireless communication module 142. After receiving the alarm signal, the mobile terminal 300 may prompt the user by means of information, voice, vibration, or the like, and the vehicle control system may prompt the user via displaying of a display screen or voice prompting according to the alarm signal. Of course, the prompting mode of the mobile terminal 300 or the vehicle control system is not limited to the above mentioned modes.

Preferably, the wireless communication module 142 may be a Bluetooth module, a Wi-Fi module or a radio frequency identification (RFID) module, or the like, however, it is not limited to the foregoing wireless connection modules, and may also be in other wireless connection modes to realize a wireless connection. In addition, the mobile terminal 300 of the present disclosure includes, but is not limited to, a mobile phone, a tablet computer, a smart watch, a smart bracelet, or other mobile device.

Continuing in conjunction with FIGS. 1-2, 13-14 and 24, in the present disclosure, the alarm device 150 and the transfer control device 140 are preferably provided independently, and the alarm device 150 is installed at a front end of the base 210 and exposed on an upper surface of the base 210 so as to be easily viewed by the user, and the alarm device 150 may also be installed at any other position of the child safety seat 200 that is convenient for observing. Moreover, the alarm device 150 and the transfer control device 140 may be electrically connected by wired or wireless modes.

In the present disclosure, the alarm device 150 may be at least one of a sound alarm apparatus, a light emitting alarm apparatus, a vibration alarm apparatus and a display alarm apparatus, but is not limited thereto. When the transfer control device 140 does not receive at least one of the first detection signal, the second detection signal and the third detection signal and sends out the alarm signal, the alarm device 150 gives an alarm according to the received alarm signal. The alarm mode may be at least one of sound alarm, light alarm, vibration alarm, pattern alarm and text information alarm, so as to remind the user that at least one of the top tether 230, the ISOFIX connector 240 and the buckle 250 is not installed in place.

In a preferred embodiment, the alarm device 150 includes a first alarm apparatus 151 and a second alarm apparatus 152. The first alarm 151 is a sound alarm apparatus and one first alarm is provided. The first alarm apparatus 151 is configured to send out an alarm prompt tone. The second alarm apparatus 152 is a light alarm apparatus and are provided in plural, and the second alarm apparatuses 152 are configured to indicate installation states of the top tether 230, the ISOFIX connector 240 and the buckle 250, respectively.

More specifically, the first alarm apparatus 151 is preferably a buzzer, and the second alarm apparatus 152 is preferably an LED lamp and three second alarm apparatuses 152 are provided. The three second alarm apparatuses 152 correspond to the first detection signal, the second detection signal and the third detection signal respectively, and are configured to indicate connection states of the top tether 230, the ISOFIX connector 240 and the buckle 250 respectively. That is, the transfer control device 140 generates and sends out an alarm signal when at least one of the first detection signal, the second detection signal and the third detection signal is not received. The alarm device 150 triggers the buzzer to send out an alarm sound according to the received alarm signal to prompt the user, and at the same time triggers the corresponding LED lamp to light up or flash so as to clearly prompt the user which component is not installed in place, and facilitate the user to quickly view and re-install.

It can be understood that the number of the second alarm apparatus 152 may be flexibly selected as desired. For example, when several components need to be detected, the number of the second alarm apparatus 152 may be set according to the number of the components to be detected, or when several sites on the same component need to be detected, the number of the second alarm apparatus 152 may be correspondingly set according to the number of sites to be detected, so as to achieve the accurate indication. In addition, only one alarm light may also be provided to achieve a warning effect.

It can be understood that the alarm device 150 may be integrated with the transfer control device 140, and the transfer control device 140 is installed as long as the first alarm apparatus 151 and the second alarm apparatus 152 are exposed on the surface of the child safety seat 200 so as to be easily observed by the user.

With reference to FIGS. 1-25 again, in the present disclosure, the transfer control device 140 may be integrated with the first detection device 110, the second detection device 120, the third detection device 130 and the alarm device 150 as long as detectors of the first detection device 110, the second detection device 120 and the third detection device 130 correspond to the components to be detected (as described in detail below). The arrangement mode of the alarm device 150 is as described above. The transfer control device 140 and the first detection device 110, the second detection device 120, the third detection device 130 and the alarm device 150 may be provided independently from one another. When the devices are provided independently, the transfer control device 140 is electrically connected with the first detection device 110, the second detection device 120 and the third detection device 130 by wired or wireless modes (as described in detail below), and the arrangement mode of the alarm device 150 is as described above. In this way, the transfer control device 140 may be provided in the child safety seat 200 or in the vehicle. Different embodiments of the safety warning system 100 for the child safety seat of the present disclosure are respectively described below.

First, with reference to FIGS. 1-14, in the first embodiment of the safety warning system 100 for the child safety seat of the present disclosure, the transfer control device 140 is integrated with the first detection device 110, the second detection device 120 and the third detection device 130, specifically they are integrated on the same circuit board, and the transfer control device 140 is installed inside the base 210, as shown in FIG. 2. In addition, the transfer control device 140 and the alarm device 150 are provided separately, and are electrically connected to each other through wires therebetween. The arrangement mode of the alarm device 150 is as described above and will not be described again.

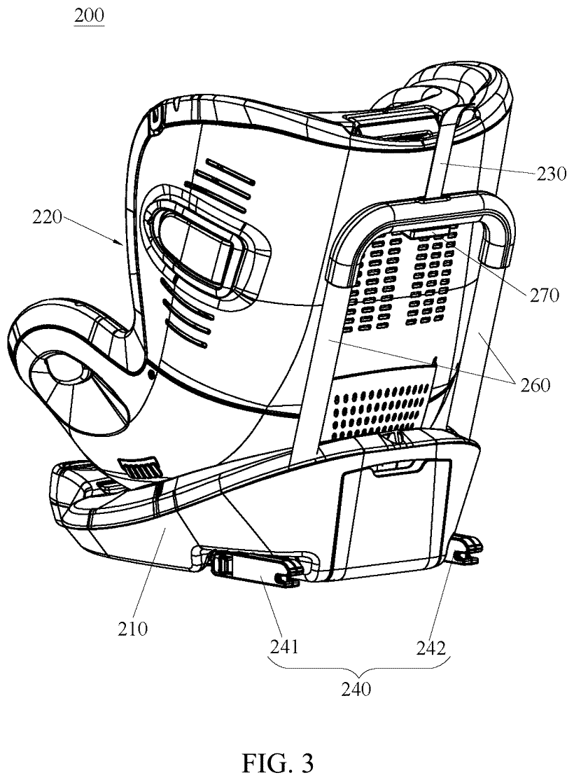

In conjunction with FIGS. 3-8 and 13-14, in this embodiment, a first detection device 110 is provided. The first detection device 110 includes a first detector 111. The first detector 111 is provided on the moving path of the top tether 230 for detecting whether the top tether 230 is in the tensioned state, and is electrically connected to a circuit board of the transfer control device 140 through wires. When the top tether 230 is tensioned to act on the first detector 111 to generate a sensing signal, the first detection device 110 generates a first detection signal, and the transfer control device 140 may obtain the first detection signal.

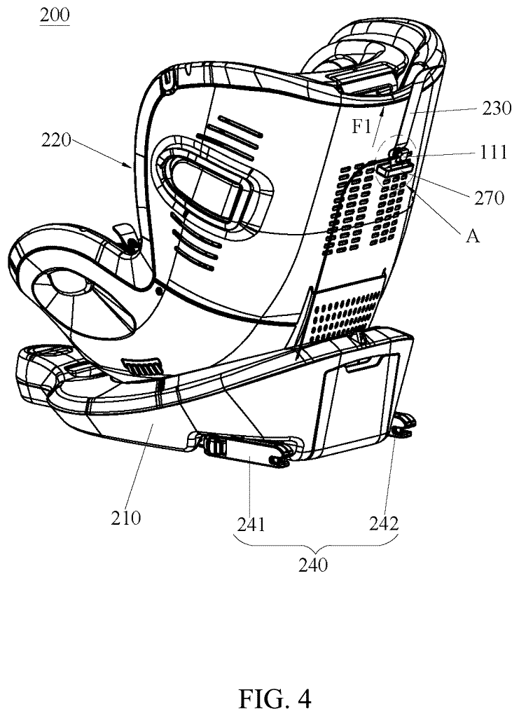

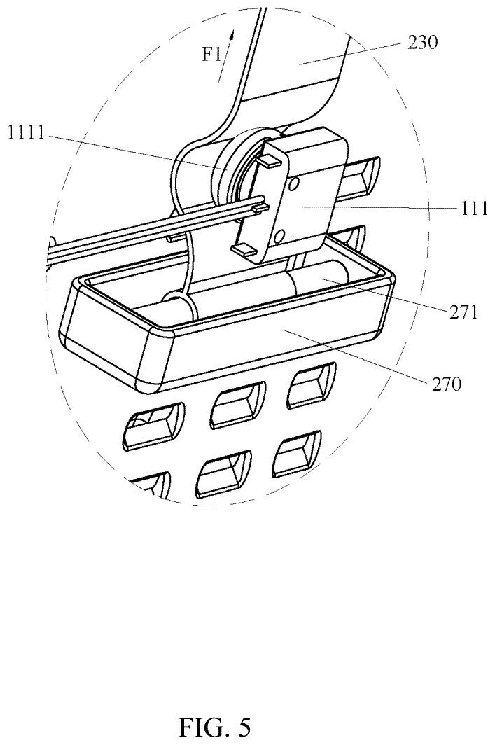

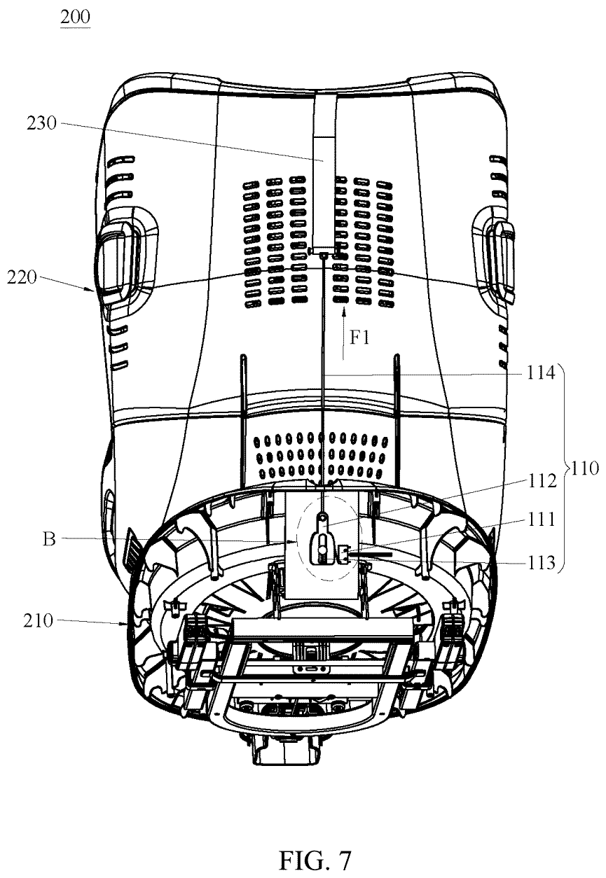

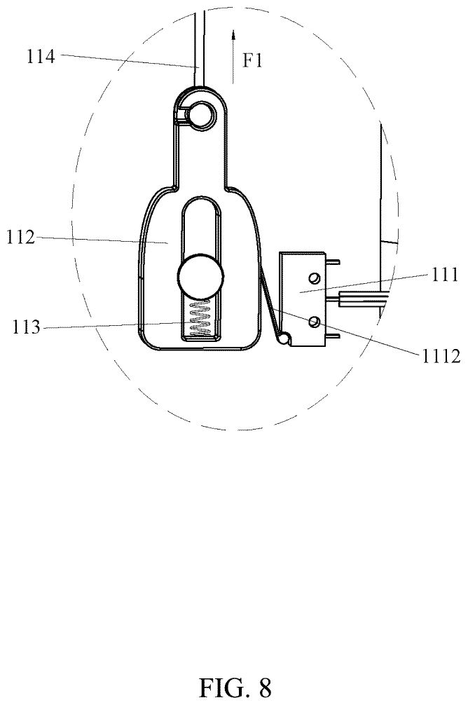

In this embodiment, the first detector 111 is preferably a mechanical switch, which includes, but is not limited to, a button switch and an elastic sheet switch. When the button switch shown in FIGS. 4-5 is selected, the first detector 111 has a button 1111, and the first detector 111 is installed on the base 210 or a backrest of the seat body 220 and enables the button 1111 to protrude on the moving path of the top tether 230. When the elastic sheet switch shown in FIG. 7-8 is selected, the first detector 111 has an elastic sheet 1112, and the first detector 111 is installed on the base 210 or the backrest of the seat body 220 and enables the elastic sheet 1112 to protrude on the moving path of the top tether 230. Therefore, when the top tether 230 is tensioned in the direction shown by an arrow F1 in FIGS. 4-5 and 7-8, the top tether 230 will apply an acting force to the button 1111 or the elastic sheet 1112 of the first detector 111 so as to close the button 1111 or the elastic sheet 1112, so that a detection circuit of the first detection device 110 is conducted and generates the first detection signal. When the top tether 230 is loosed, no acting force is applied on the first detector 111 (i.e., the mechanical switch), and the first detector 111 is automatically disconnected. At this time, the first detection device 110 is unable to generate the first detection signal.

It can be understood that the first detector 111 is not limited to the mechanical switch, and may also adopt other modes to perform detection, for example, any one of a contact sensor, a pressure sensor, an infrared sensor and a displacement sensor may also be used, which is not limited thereto. Taking the pressure sensor as an example, when it detects that a pressure applied by the top tether 230 reaches a preset value, the pressure sensor generates a sensing signal, and the first detection device 110 generates the first detection signal according to the sensing signal.

Continuing in conjunction with FIGS. 3-5, in a specific embodiment of the present embodiment, the first detector 111 is provided on the back of the seat body 220 and corresponds to the top tether 230. More specifically, a support rod 260 is also provided at the rear end of the base 210 and has a hollow structure. A fixing block 270 is provided on the top of the support rod 260 and a fixing rod 271 is provided on the fixing block 270. A lower end of the top tether 230 is connected to the fixing rod 271, and a hook (not shown) is provided on an upper end of the top tether for connecting to the top of the vehicle. The first detector 111 may be installed on one of the following positions: the top of the support rod 260, the fixing block 270, and the back of the seat body 220. Preferably, it may be installed on the fixing block 270 corresponding to a side of the top tether 230, so that the top tether 230 may act on the first detector 111 when it is tensioned, and the wires electrically connected to the first detection member 111 are routed inside the support bar 260. Therefore, the arrangement of the support rod 260 not only facilitates installing of the top tether 230, but also facilitates routing of the wires of the first detection device 110, so that the external structure of the child safety seat 200 is simple and artistic.

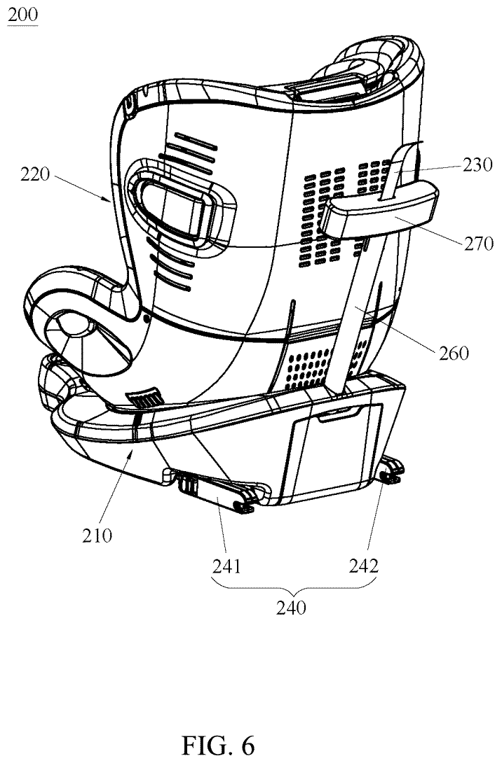

As shown below in conjunction with FIGS. 6-8, in another specific embodiment of the present embodiment, the first detector 111 is installed at a rear end of the base 210, the lower end of the top tether 230 may be directly connected to the base 210, and the first detector 111 may be located on the moving path of the top tether 230. Similarly, the top tether 230 may act on the first detector 111 to enable the first detection device 110 to generate the first detection signal.

In this specific embodiment, in order to ensure accurate action on the first detector 111 and thus ensure the accuracy of detection, the first detection device 110 is also provided with a first trigger 112 and an elastic member 113. The first trigger 112 is movably provided on the base 210 and is connected to the top tether 230. The elastic member 113 may abut against the first trigger 112. During the tension process of the top tether 230, the first trigger 112 is driven to move and act on the button 1111 or elastic sheet 1112 of the first detector 111, so that the first detector 111 is closed, and then the first detection device 110 generates the first detection signal. When the top tether 230 is not tensioned, an elastic force of the elastic member 113 resets the first trigger 112 to release the button 1111 or elastic sheet 1112 of the first detector 111, and then the first detector 111 is disconnected.

With continuing reference to FIGS. 7-8, in this specific embodiment, the first detection device 110 also includes a traction member 114. The traction member 114 is accommodated inside the support rod 260 and has two ends respectively connected to the first trigger 112 and the top tether 230. The lower end of the top tether 230 is slidably connected to the top of the support rod 260. When the top tether 230 is tensioned upward by an external force, the first trigger 112 is pulled through the traction member 114 to move upward in a direction shown by the arrow F1 in FIGS. 7-8. During the movement of the first trigger 112, it acts on the elastic sheet 1112 of the first detector 111 to close the first detector 111.

It should be noted that in the above two specific embodiments, the support rod 260 may be formed by connecting a plurality of rods as shown in FIG. 3, or may be composed of only one rod as shown in FIG. 6. However, the installation of the first detector 111 and the top tether 230 in this embodiment is not affected by any of the above specific structures of the support rod, and the specific structure of the support rod 260 is not limited.

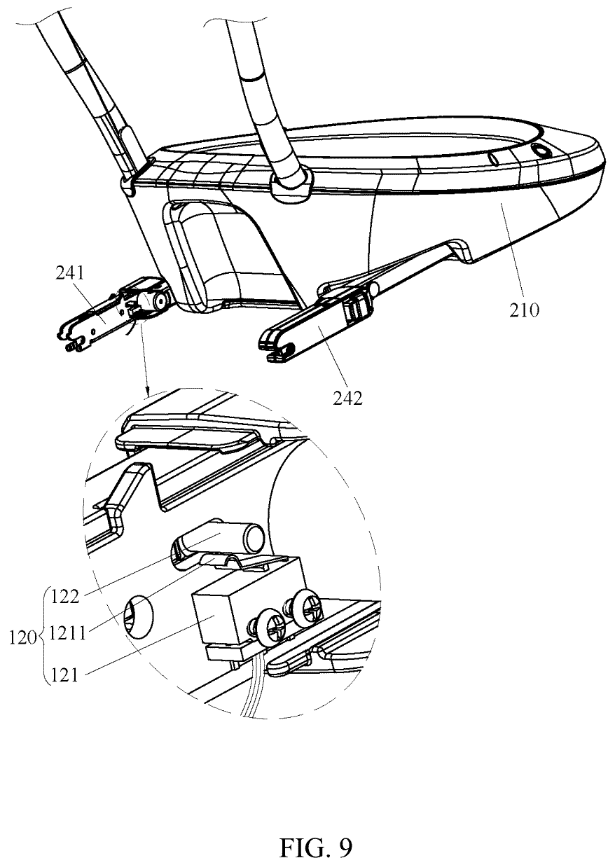

Further with reference to FIGS. 9 and 13-14, in this embodiment, two second detection devices 120 are provided. The two second detection devices 120 are respectively arranged on the ISOFIX connectors 240 to detect the installation state of two ISOFIX connectors 240, and have the same structure and arrangement mode.

As shown in FIG. 9, each of the second detection devices 120 includes a second detector 121. The second detector 121 is installed on the ISOFIX connector 240 to detect the installation state thereof, and is electrically connected to the circuit board of the transfer control device 140 through wires. When the ISOFIX connector 240 is installed in place, the ISOFIX connector acts on the second detector 121 to generate a sensing signal, so that the second detection device 120 generates a second detection signal, and the transfer control device 140 may obtain the second detection signal.

In this embodiment, the second detector 121 is preferably a mechanical switch, and more preferably an elastic sheet switch. The second detector 121 has an elastic sheet 1211 protruding on a moving path of the ISOFIX connector 240. The second detector 121 may also be a button switch or any other type of mechanical switch. The second detector 121 is electrically connected to the circuit board of the transfer control device 140 through wires. When the ISOFIX connector 240 is installed in place, it acts on the elastic sheet 1211 of the second detector 121 to close the second detector, so that the detection circuit of the second detector 120 is conducted and generates the second detection signal.

Similarly, the second detection device 121 is not limited to a mechanical switch, for example, it may also be any one of a contact sensor, a pressure sensor, an infrared sensor and a displacement sensor, which is not limited thereto. Taking the contact sensor installed in the ISOFIX connector 240 as an example, the ISOFIX connector 240 is installed in place and may act on the contact sensor, so that the contact sensor generates a sensing signal, and the second detection device 120 generates a second detection signal according to the sensing signal.

Further with reference to FIG. 9, in this embodiment, the second detection device 120 also includes a second trigger 122 movably provided and connected to the ISOFIX connector 240. During the installation process of the ISOFIX connector 240, the second trigger 122 is driven to move and act on the elastic sheet 1211 of the second detector 121, so as to close the second detector 121 (i.e., the mechanical switch). After the ISOFIX connector 240 is installed in place, the second trigger 122 will always keep the second detector 121 in a closed position, so that a detection circuit of the second detection device 120 is conducted and generates a second detection signal. When the ISOFIX connector 240 is released and detached from a locking member on the vehicle, no acting force is applied on the second detector 121 (i.e., the mechanical switch) and the second detector is automatically disconnected. At this time, the second detection device 120 is unable to generate the first detection signal.

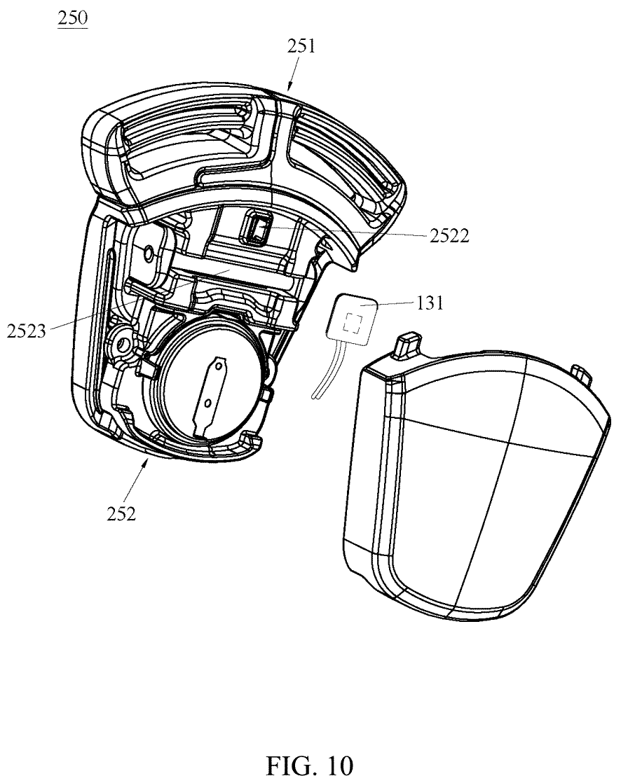

Combining with FIGS. 10-13, the third detection device 130 includes a third detector 131. The third detector 131 is provided on a buckling path of the buckle 250 and electrically connected to the circuit board of the transfer control device 140 through wires. When the buckle 250 is buckled and acts on the third detector 131, the third detector generates a sensing signal, so that the third detection device 130 generates a third detection signal, and the transfer control device 140 may obtain the third detection signal.

With continuing reference to FIGS. 10-12, in this embodiment, the third detector 131 is preferably a mechanical switch, and the mechanical switch is disposed inside a male buckle 251 or a female buckle 252 and protrudes on an insertion path between the male buckle and the female buckle. When the male buckle 251 is buckled with the female buckle 252, it may act on and then close the mechanical switch; and when the male buckle 251 is detached from the female buckle 252, the mechanical switch is automatically disconnected.

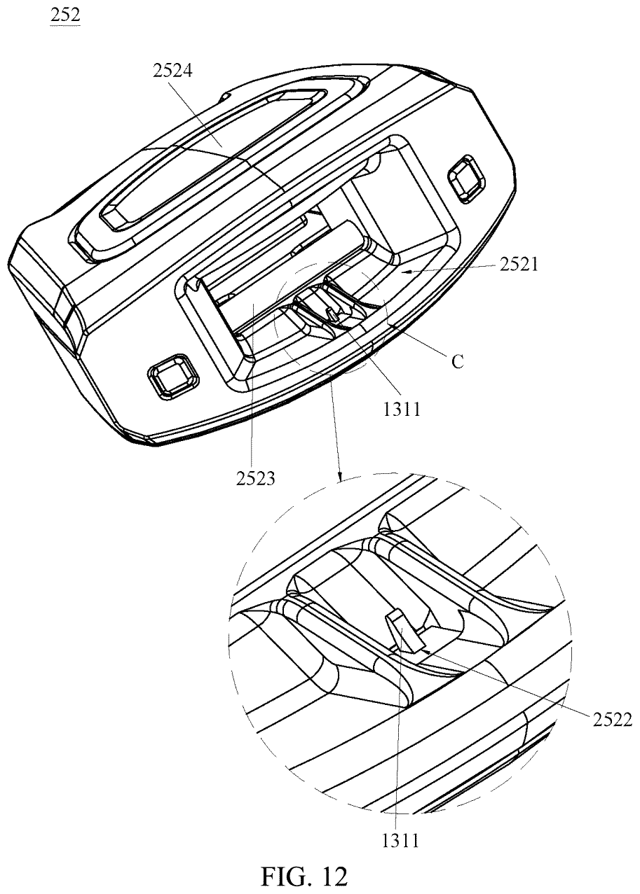

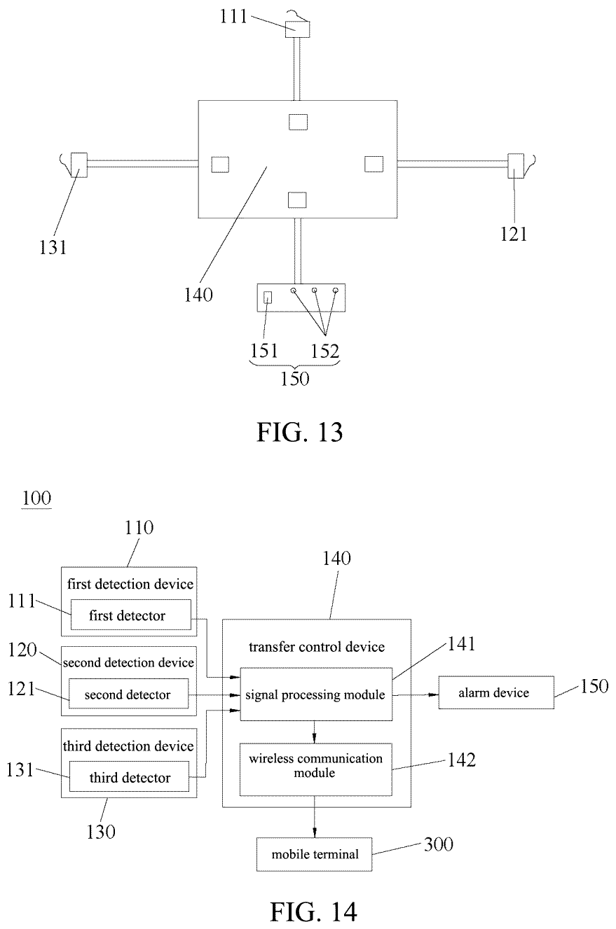

In this embodiment, the third detector 131 is disposed inside the female buckle 252. When the male buckle 251 is inserted into the female buckle 252, it may act on the third detector 131 to close the third detector. More specifically, the female buckle 252 is provided with a slot 2521, and is also provided with a through hole 2522 communicated with the slot 2521. The third detector 131 is disposed inside the female buckle 252, and its button 1311 protrudes into the slot 2521 through the through hole 2522, as shown in FIGS. 12-13. In addition, a locking rod 2523 is also provided in the slot 2521 of the female buckle 252 and is movable, and the female buckle 252 is also provided with an unlocking member 2524 for driving the locking rod 2523 to move. Therefore, when the male buckle 251 is inserted into the slot 2521, it may be engaged with the locking rod 2523, and when the unlocking member 2524 is pressed, the locking rod 2523 may be driven to move and disengage from the male buckle 251, so that the male buckle 251 and the female buckle 252 may be separated from each other.

Correspondingly, the male buckle 251 has an inserting end 2511. A driving rib 2512 is provided protruding from a rear end of the inserting end 2511, and a locking groove 2513 is recessed on a front end of the inserting end 2511. When the male buckle 251 is inserted into the slot 2521, the locking groove 2513 at the front end of the inserting end is engaged with the locking rod 2523, and the driving rib 2512 at the rear end of inserting end presses and closes the button 1311 of the third detector 131, so that the third detection device 130 generates the third detection signal. When the locking rod 2523 is driven by the unlocking member 2524 to move and engage from the locking groove 2513, the male buckle 251 may be pulled out of the slot 2511. At this time, no acting force is applied on the third detector 131, and the third detector is automatically disconnected, so that the third detection device 130 is unable to generate the third detection signal.

It can be understood that the third detector 131 is not limited to a mechanical switch, and may also be any one of a contact sensor, a pressure sensor, an infrared sensor and a displacement sensor. Taking the contact sensor as an example, it is disposed inside the male buckle 251 or the female buckle 252. When the male buckle 251 is inserted into the slot 2521 of the female buckle, it may act on the contact sensor to generate a sensing signal, so that the third detection device 130 generates and sends out the third detection signal.

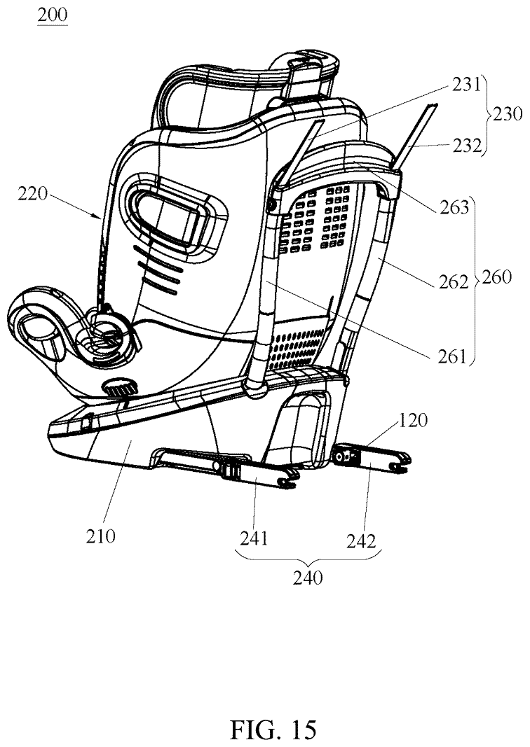

Further with reference to FIGS. 15-19, a second embodiment of the safety warning system 100 for the child safety seat of the present disclosure is mainly different from the first embodiment in that, the number of the first detection device 110 is different, and other parts in the second embodiment that are same as that in the first embodiment will not be described again.

In this embodiment, the top tether 230 includes a left woven belt 231 and a right woven belt 232. The left woven belt 231 and the right woven belt 232 are respectively fixed to the base 210 or the seat body 220. Upper ends of the left woven belt 231 and the right woven belt 232 are connected with each other and have a hook (not shown) installed thereon. When the hooks are connected to the top of the vehicle, the left woven belt 231 and the right woven belt 232 may be tensioned.

In this embodiment, the first detection device 110 is provided corresponding to each of the left woven belt 231 and the right woven belt 232, that is, two first detection devices 110 are provided to respectively detect whether the left woven belt 231 and the right woven belt 232 are in the tensioned states. When the top tether 230 is tensioned, the two first detection devices 110 send out the first detection signal respectively, and monitor whether the left woven belt 231 and the right woven belt 232 are in the tensioned states.

The two first detection devices 110 have the same structure, and each of the first detection devices 110 may be arranged as described in the first embodiment or in other arrangement modes. Compared with the first embodiment, the first detection device 110 in this embodiment is further provided with a slider 115.

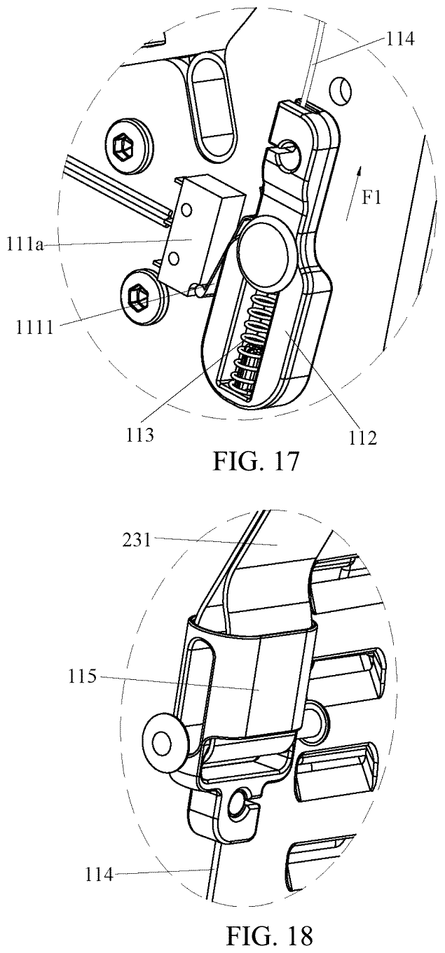

With continuing reference to FIGS. 15-19, the first detection device 110 provided corresponding to the left woven belt 231 is taken as an example. The first detection device 110 includes a first detector 111a, a first trigger 112, an elastic member 113, a traction member 114 and a slider 115. The first trigger 112 is movably provided at a side of the base 210, and is connected to the left woven belt 231 through the traction member 114. The elastic member 113 may abut against the first trigger 112. The first detector 111a is electrically connected to a circuit board of the transfer control device 140 through wires, and is located at a side of the first trigger 112. The slider 115 is slidably installed on the back of the seat body 220, and is connected with the left woven belt 231 and the traction member 114 respectively. Therefore, during the tension process of the top tether 230, the slider 115 is pulled to move upward in a direction shown by an arrow F1 in FIG. 17, and then pulls the first trigger 112 to move upward in the direction shown by the arrow F1 in FIG. 17 through the traction member 114. In this process, the first trigger 112 acts on the first detector 111a to generate a first detection signal. In addition, during the upward movement of the first trigger 112, it acts on and deform the elastic member 113. When the top tether 230 is released, the elastic member 113 recovers its deformation and drives the first trigger 112 to move downward, so that the first detector 111a is released and the first detection device 110 is unable to generate the first detection signal.

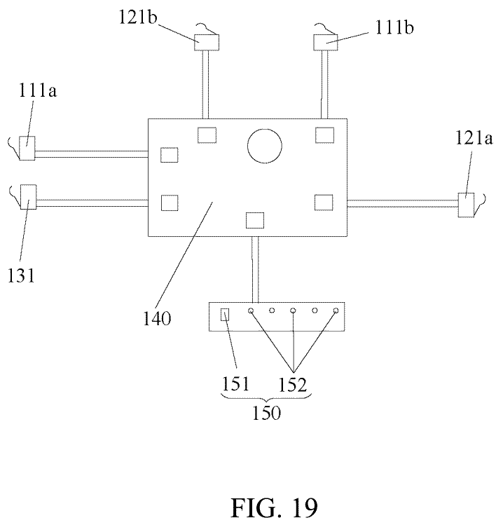

It can be understood that the first detection device 110 provided corresponding to the right woven belt 232 may be inferred from the above description, in which a first detector 111b is electrically connected to the circuit board of the transfer control device 140 through wires, as shown in FIG. 19. Other parts of the first detector 111b are not described repeatedly. It should also be noted that the first detectors installed corresponding to the left woven belt 231 and the right woven belt 232 are expressed as 111a and 111b respectively only for convenience of illustration, and they are the same.

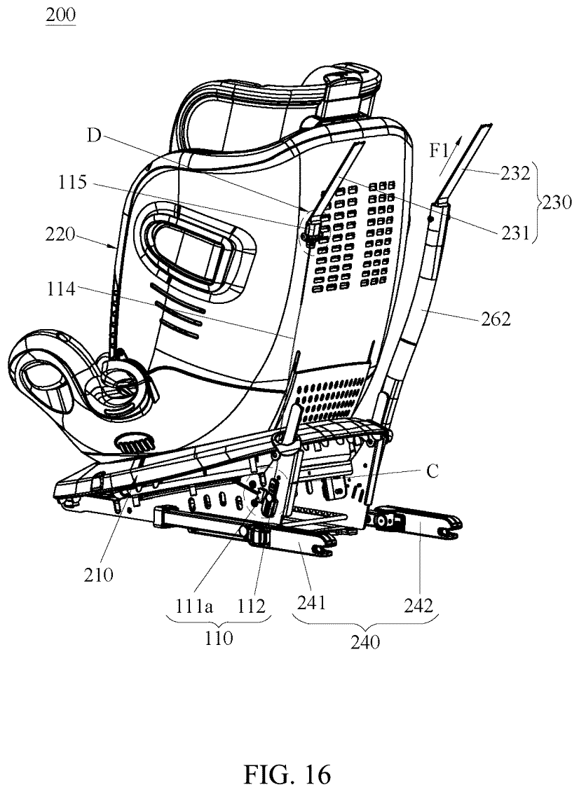

With continuing reference to FIGS. 15-16, in this embodiment, the support rod 260 provided at the rear end of the base 210 specifically includes a left support rod 261, a right support rod 262 and a transverse support rod 263 connected to top portions of the left support rod and the right support rod. Each of the left support rod, the right support rod and the transverse support rod is in a hollow structure. The left woven belt 231 of the top tether 230 penetrates through the left support rod 261 and the right woven belt 232 penetrates through the right support rod 262, and upper ends of the left woven belt and the right woven belt respectively extend out of the left support rod 261 and the right support rod 262, and are fixedly connected. The traction member 114 penetrates through the left support rod 261 and the right support rod 262. In this way, an appearance of the child safety seat 200 can be simple and artistic.

With reference to FIG. 19, in this embodiment, two second detection devices 120 are also provided, and have the same arrangement mode as that of the above embodiment. In this embodiment, the second detectors installed on the two ISOFIX connectors 240 are expressed as 121a and 121b respectively for convenience of illustration, and the two second detectors 121a, 121b are electrically connected to the circuit board of the transfer control device 140 through wires.

In conjunction with FIGS. 15-19 again, in this embodiment, in order to accurately prompt the user, two more second alarm apparatuses 152 are added in the alarm device 150 on the basis of the arrangement modes as described above, that is, a total of five second alarm apparatuses 152 are provided, which are respectively configured to indicate connection states of the left woven belt 231, the right woven belt 232, the two ISOFIX connectors 240 and the buckle 250. Specifically, when the left woven belt 231 or/and the right woven belt 232 are not tensioned, the first detector 111a or/and 111b are disconnected, and the transfer control device 140 sends out an alarm signal to control the second alarm apparatuses 152 corresponding to the left woven belt or/and the right woven belt to give an alarm; when at least one of the two ISOFIX connectors 240 is not installed in place, the second detector 121a or/and 121b are disconnected, and the transfer control device 140 sends out an alarm signal to control the second alarm apparatuses 152 corresponding to the two ISOFIX connectors to give an alarm; and when the buckle 250 is not buckled, the third detector 131 is disconnected, and the transfer control device 140 sends out an alarm signal to control the second alarm apparatus 152 corresponding to the buckle 250 to give an alarm.

It should be noted that the structure and working mode of the alarm device 150 not mentioned here are the same as the modes described above.

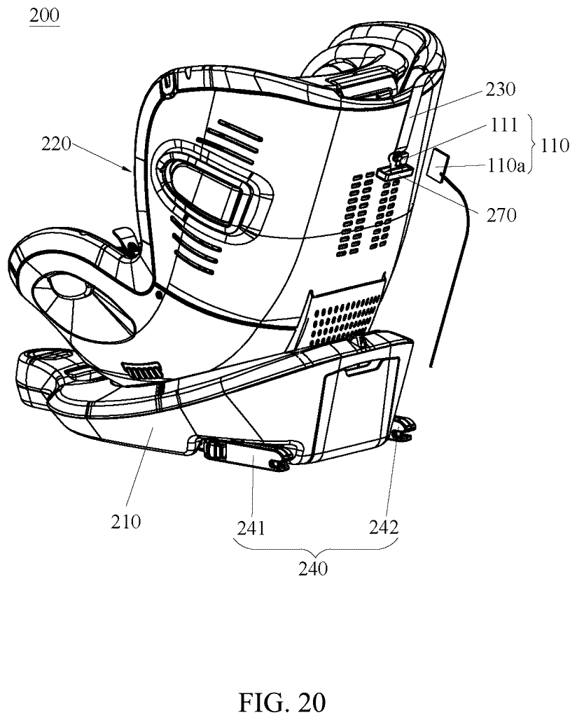

Further with reference to FIGS. 20-24, a third embodiment of the safety warning system 100 for the child safety seat of the present disclosure is mainly different from the first embodiment in that: the transfer control device 140 and the first detection device 110, the second detection device 120, the third detection device 130 and the alarm device 150 are provided independently, and the first detection device 110, the second detection device 120, the third detection device 130 and the alarm device 150 are electrically connected with the transfer control device 140 through wires. The specific arrangement of the alarm device 150 may be any of the modes as described above, and will not be repeatedly described.

In the embodiment, the first detection device 110 also includes a first detection circuit board 110a, and the first detector 111 is provided on the moving path of the top tether 230 and electrically connected to the first detection circuit board 110a. The first detection circuit board 110a may be installed on the fixing block 270, the back of the seat body 220 or the base 210, and the first detection circuit board 110a is electrically connected to the transfer control device 140 through wires. Therefore, when the top tether 230 is tensioned, it acts on the first detector 111 to generate a sensing signal, and the first detection device 110 generates a first detection signal according to the sensing signal of the first detector 111 and sends the first detection signal to the transfer control device 140.

Further combining with FIGS. 20-24, in this embodiment, the second detection device 120 also includes a second detection circuit board 120a, and the second detection circuit board 120a is provided in the ISOFIX connector 240 and electrically connected to the transfer control device 140 through wires. The second detector 121 is electrically connected to the second detection circuit board 120a. When the ISOFIX connector 240 is installed in place, the ISOFIX connector acts on the second detector 121 to generate a sensing signal, and the second detection device 120 generates a second detection signal according to the sensing signal.

Correspondingly, the third detection device 130 also includes a third detection circuit board 130a disposed inside the female buckle 252 and electrically connected to the transfer control device 140 through wires. The third detector 131 is electrically connected to the third detection circuit board 130a and disposed inside the female buckle 252. A button 1311 of the third detector 131 protrudes through a through hole 2522 on a buckling path of the buckle 250. When the buckle 250 is buckled, it acts on the third detector 131, and the third detection device 130 generates and sends out a third detection signal.

It can be understood that the third detection circuit board 130a and the third detector 131 may also be disposed inside the male buckle 251.

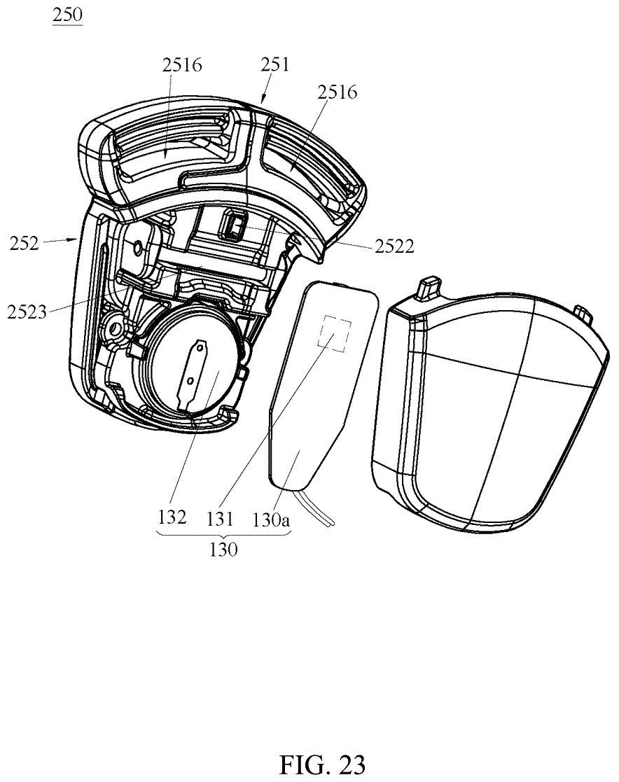

With reference to FIG. 23 again, in this embodiment, the third detection device 130 also includes a power supply 132, and the power supply 132 may be a button or soft pack lithium battery. The lithium battery is installed in the female buckle 120 and electrically connected with the third detection circuit board 130a for supplying power to the third detection circuit board 130a and the third detector 131. Therefore, when the third detector 131 is closed, a circuit on the third detection circuit board 130a is conducted to generate a third detection signal. The power supply 132 may also adopt other types of batteries or may be integrated on the third detection circuit board 130a.

In this embodiment, the number, installation mode and working principle of the first detection device 110, the second detection device 120 and the third detection device 130 may be provided as any of the above first and second embodiments, and will not be repeatedly described.

Further with reference to FIGS. 20-23 and 25, a fourth embodiment of the safety warning system 100 for the child safety seat of the present disclosure is mainly different from the third embodiment in that: the transfer control device 140 is wirelessly connected with the first detection device 110, the second detection device 120 and the third detection device 130 respectively, reducing the line connection between devices, and simplifying the connection of the safety warning system 100 for the child safety seat. In addition, since the devices are provided independently and connected with each other wirelessly, the transfer control device 140 may also be installed on the vehicle such as a control platform of the vehicle, in addition to being installed on the child safety seat 200, so that the installation of the transfer control device 140 is more flexible and easier to connect wirelessly with more devices.

In this embodiment, the structure and arrangement of the first detection device 110, the second detection device 120, the third detection device 130 and the transfer control device 140 are the same as those in the above third embodiment, and will not be described repeatedly. The wireless connection part will be described below.

As shown in FIG. 25, in this embodiment, the first detection device 110 also includes a first wireless module 112 provided on the first detection circuit board 110a, and the first wireless module 112 is configured to wirelessly connect with a wireless communication module 142 of the transfer control device 140. Therefore, the first detection signal of the first detection device 110 is sent to the transfer control device 140 through the first wireless module 112.

Correspondingly, the second detection device 120 also includes a second wireless module 122 provided on the second detection circuit board 120a, and the second wireless module 122 is configured to wirelessly connect with the wireless communication module 142 of the transfer control device 140. The second detection signal of the second detection device 120 is sent to the transfer control device 140 through the second wireless module 122. The third detection device 130 also includes a third wireless module 132 provided on the third detection circuit board 130a, and the third wireless module 132 is configured to wirelessly connect with the wireless communication module 142 of the transfer control device 140. The third detection signal of the third detection device 130 is sent to the transfer control device 140 through the third wireless module 132.

In this embodiment, the first wireless module 112, the second wireless module 122, the third wireless module 132 and the wireless communication module 142 are preferably Bluetooth modules, which are not limited thereto. For example, a Wi-Fi module, a radio frequency identification (RFID) module and the like may also be used to realize wireless connection.

In conclusion, the safety warning system 100 for the child safety seat of the present disclosure has a first detection device 110, a second detection device 120 and a third detection device 130, which are respectively configured to detect whether the top tether 230, ISOFIX connector 240 and buckle 250 are installed or buckled, and send out a first detection signal, a second detection signal and a third detection signal. When at least one of the first, second and third detection signals is not received by the transfer control device 140, it sends out an alarm signal to remind the user whether the top tether 230 is installed or buckled, ISOFIX connector 240 and buckle 250 are correct, so as to ensure the safety and comfort of the child seating in the vehicle, and improve the installation efficiency of the child safety seat 200.

The structures of other parts of the child safety seat 200 of the present disclosure are conventional arrangement modes for those skilled in the art, and will not be described in detail here.

A second aspect of the present disclosure provides a child safety seat.

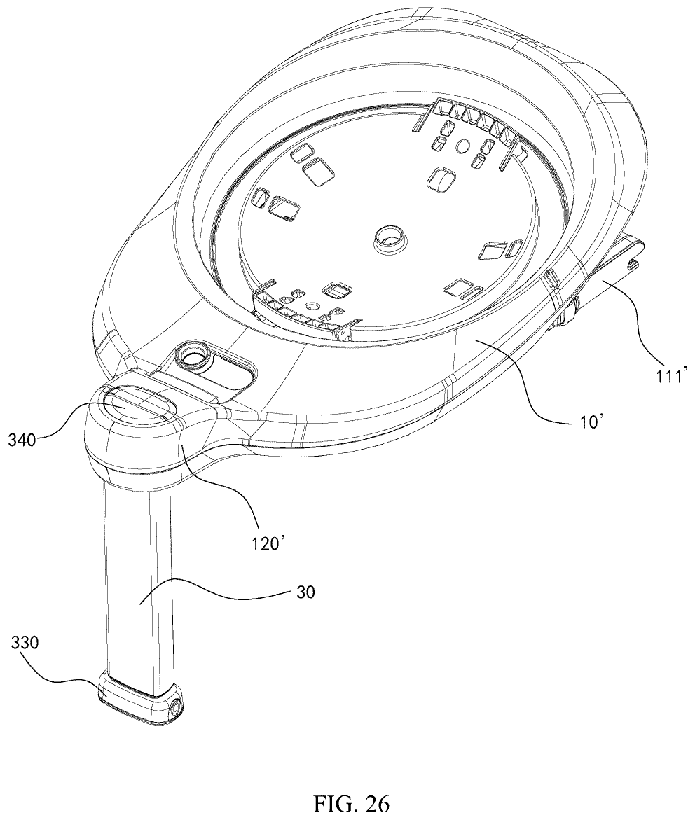

FIG. 26 is a perspective view of a child safety seat of a second aspect of the present disclosure, with a seat portion removed. The child safety seat may include a base 10′, a seat portion (not shown) and a support leg 30. The seat portion may be a seat portion commonly used in the art for a child to sit thereon, and the child is restrained in the seat portion by a restraining element. The seat portion may be rotated relative to the base 10′ to have different riding directions, such as a direction facing the front of the vehicle and a direction facing the rear of the vehicle. Optionally, the seat portion may also be rotated relative to the base 10′ to face a side of the vehicle, so that the child may be placed in the seat portion.

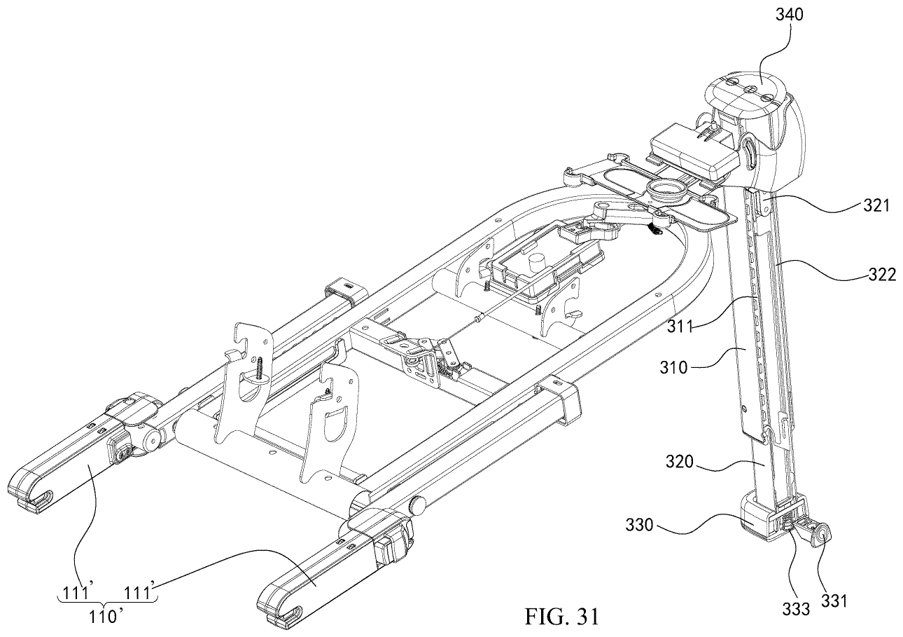

As shown in FIG. 26, the support leg 30 may be disposed at the front of the base 10′ and extend from the base 10′ towards a floor of the vehicle. When the child safety seat is installed in place, the support leg 30 may abut against the floor of the vehicle and provide a supporting force. The base 10′ may have an anchoring portion 110′ extending rearward from both sides of the rear portion. The anchoring portions 110′ may be composed of two anchoring arms 111′ (see FIG. 31). The anchor portion 110′ may be an ISOFIX connector, for example. The anchoring portion 110′ may be connected (or anchored) to a corresponding interface of the vehicle seat.

The front part of the base 10′ may be formed with a support leg coupling portion 120′. The support leg 30 may pass through the base 10′ and be pivoted to the support leg coupling portion 120′ of the base 10′. The base 10′ may be provided with a display portion 340, and a position of the display portion 340 may correspond to the support leg 30. The display portion 340 may be formed as a light-transmitting panel. A grounding portion 330 may be formed on a bottom end of the support leg 30. All or a part (e.g., a lower surface) of the grounding portion 330 may be formed of an elastic or a flexible material with high friction, for example, rubber or the like. An outer contour of the grounding portion 330 may be larger than that of a middle portion of the supporting leg 30, thereby having a more stable supporting effect.

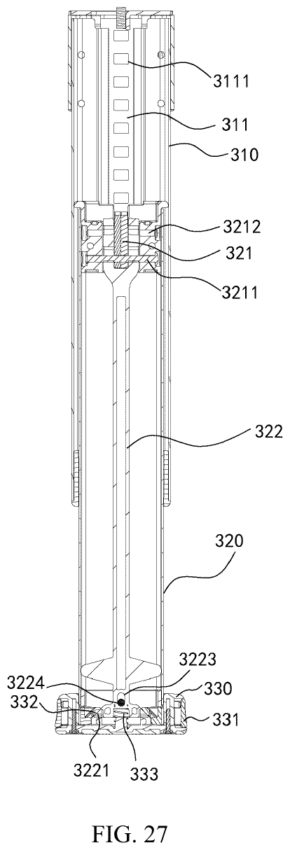

FIG. 27 is a front sectional view of the support leg of the child safety seat of the second aspect of the present disclosure. The support leg 30 may include a first tube 310 and a second tube 320 sleeved with each other. The first tube 310 may be sleeved outside the second tube 320. The first tube 310 may extend and retract with respect to the second tube 320. That is, the first tube 310 and the second tube 320 are formed as telescopic sleeves. Each of the first tube 310 and the second tube 320 may have a substantially rectangular outer contour. In the process of extension and retraction, the first tube 310 may be locked to the second tube 320 at a plurality of positions. For example, the first tube 310 and the second tube 320 may be locked to each other in a stepless manner (that is, they may be locked at any position), or they may be locked to each other in sections (that is, they may be locked at a certain number of positions). In a case where the first tube 310 is locked to the second tube 320, a pressure applied to an end (e.g., a lower end) of the second tube 320 may close a switch 520a (described in detail below).

A receiving member 311 may be disposed in the first tube 310. As shown in FIG. 27, the receiving member 311 is located between the first tube 310 and the second tube 320. An end (for example, an upper end) of the receiving member 311 is provided with a trigger portion 312 for turning on the switch 520a.

The receiving member 311 may slide up and down between the first tube 310 and the second tube 320. The receiving member 311 may be formed as an elongated sheet having a plurality of segment holes 3111 along a direction in which the first tube 310 moves relative to the second tube 320 (i.e., an up-down direction in FIG. 27).

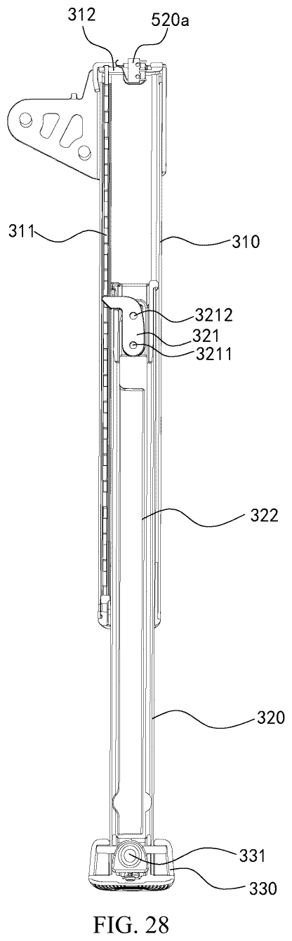

FIG. 28 is a side sectional view of the support leg of the child safety seat of the second aspect the present disclosure at an extended length. The second tube 320 may be provided with an engaging member 321. The engaging member 321 may be formed in a shape similar to “L”. The engaging member 321 may be selectively locked to different positions of the receiving member 311. For example, the engaging member 321 may be engaged by hooking in one of the segment holes 3111.

The engaging member 321 may be rotatably fixed in the second tube 320 via a pivot shaft 3211. Therefore, when the engaging member 321 is engaged in the segment hole 3111, the second tube 320 is locked with the first tube 310. It should be noted that when the second tube 320 is locked with the first tube 310, since the receiving member 311 may slide between the first tube 310 and the second tube 320, the second tube 320 may move a certain distance relative to the first tube 310. The movable distance of the second tube 320 relative to the first tube 310 is defined by a stopper provided at the top of the first tube 310. This distance may be provided as a slight distance that does not affect a supporting function of the supporting leg 30.

The second tube 320 may have a linkage 322. The linkage 322 extends in a longitudinal direction of the second tube 320 (the up-down direction in FIG. 27). The grounding portion 330 may include pressing portions 331 disposed at left and right sides. That is, the two pressing portions 331 are movably formed at both sides of the grounding portion 330, respectively. The pressing portion 331 and the engaging member 321 may be linked via the linkage 322.

Specifically, as shown in FIG. 27, an inner end of the pressing portion 331 may be formed as a first inclined surface 332, and an end (a lower end) of the linkage 322 is formed with a second inclined surface 3221. The first inclined surface 332 may be matched with the second inclined surface 3221.

The linkage 322 may be provided with an elongated slot 3223 extending in the longitudinal direction. The pin 3224 fixed in the second tube 320 passes through the elongated slot 3223 and may move relative to the elongated slot 3223. A reset member 333 may be provided between the linkage 322 and the grounding portion 330 to provide a thrust force. The reset member 333 may be a spring, for example.

When the pressing portion 331 is pressed, the pressing portion 331 moves from both sides to the middle, and the first inclined surface 332 cooperates with the second inclined surface 3221 to push the linkage 322 to move downward against a restoring force of the reset member 333.

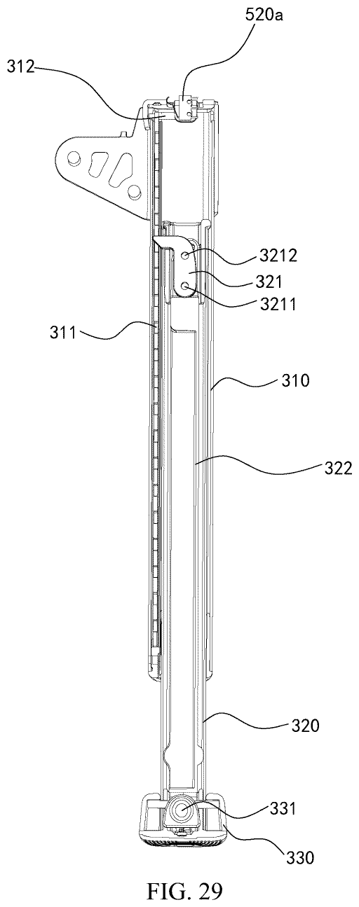

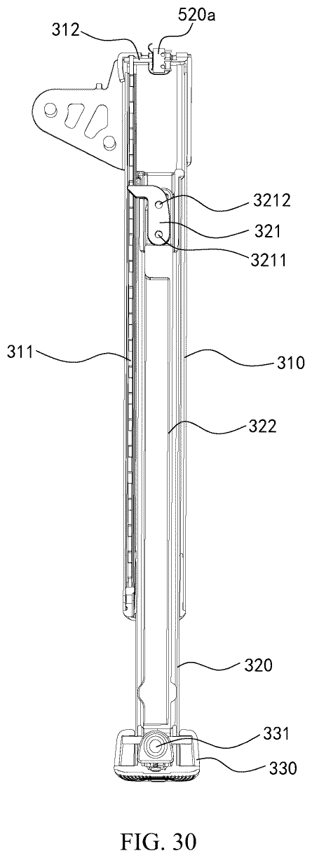

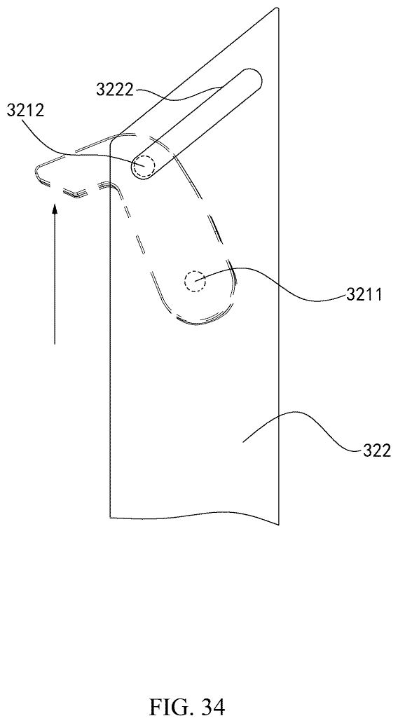

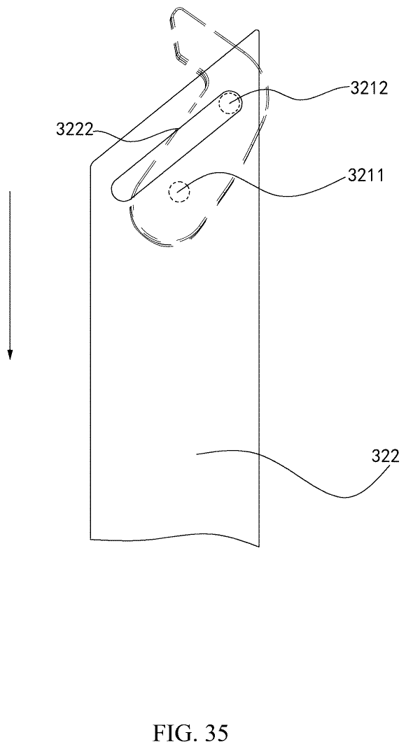

FIG. 29 is a side sectional view of the supporting leg of the child safety seat of the second aspect of the present disclosure at another extended length, in which a switch is in a turn-off state. FIG. 30 is a side sectional view of the supporting leg of the child safety seat of the second aspect of the present disclosure at another extension length, in which the switch is in a turn-on state. FIG. 34 is a schematic view of a cooperating relationship between the linkage and the engaging member of the child safety seat of the second aspect of the present disclosure. FIG. 35 is another schematic view of the cooperating relationship between the linkage and the engaging member of the child safety seat of the second aspect of the present disclosure.

A chute 3222 is formed on the other end (an upper end) of the linkage. The engaging member 321 may be coupled with the chute 3222 via an actuating shaft 3212. In FIGS. 28-30, the chute 3222 is blocked by the engaging member 321. FIGS. 34 and 35 show the cooperating relationship between the chute 3222 and the engaging member 321, in which a posture of the engaging member 321 is reflected by the pivot shaft 3211 and the actuating shaft 3212. The pivot shaft 3211 and the actuating shaft 3212 are shown in broken lines in FIGS. 34 and 35, and arrows in FIGS. 34 and 35 show moving directions of the linkage 322.

When the pressing portion 331 is pressed so that the linkage 322 move downward (as shown in FIG. 35), since the pivot shaft 3211 is fixed, the actuating shaft 3212 is driven by the chute 3222 to move towards an upper right of the chute 3222. This movement corresponds to a clockwise movement of the engaging member 321 about the pivot shaft 3211, and the engaging member 321 is disengaged from the receiving member 311, so that the first tube 310 may freely move relative to the second tube 320 (for example, from a position shown in FIG. 28 to a position shown in FIG. 29).

Thereafter, when the pressing portion 331 is released, the linkage 322 is pushed upward by the reset member 333 (as shown in FIG. 34), and since the pivot shaft 3211 is fixed, the actuating shaft 3212 is driven by the chute 3222 to move towards a lower left of the chute 3222. This movement corresponds to a counterclockwise movement of the engaging member 321 about the pivot shaft 3211, so that the engaging member 321 is locked with the receiving member 311. When the engaging member 321 is locked with the receiving member 311, the linkage 322 is unable to move further upward.

When the engaging member 321 is locked with the receiving member 311, the second tube 320 and the receiving member 311 move upward for a certain distance (from a state of FIG. 29 to a state of FIG. 30) with respect to the first tube 310 since the grounding portion 330 is in contact with the ground, so that the trigger portion 312 fixed at the upper end of the receiving member 311 may move with respect to the switch 520a fixed at the upper end of the first tube 310, and the switch 520a may be closed.

In a case that the engaging member 321 is actuated to unlock the receiving member 311, or that the engaging member 321 is locked with the receiving member 311 but the support leg 30 does not touch the ground, the receiving member 311 may move downward for a certain distance relative to the first tube 310 due to the gravity of the receiving member 311 itself until the upper end of the first tube 310 stops the trigger portion 312. At this time, the trigger 312 is separated from the switch 520a, so that the switch 520a is turned off.

When the child safety seat is installed, it is necessary to press the pressing portion 331 to adjust a length of the support leg 30 by relatively moving the first tube 310 and the second tube 320 until the support leg 30 just stably contacts the floor of the vehicle. Due to the above structure of the support leg 30, the contact of the support leg 30 with the floor of the vehicle will not turn on the switch 520a during the length adjustment of the support leg 30. In other words, when the engaging member 321 and the receiving member 311 are unlocked, application of the thrust force to the grounding portion 330 does not turn on the switch 520a, thereby avoiding the possibility of incorrect recognition, for example, a case that the alarm device of the child safety seat may mistakenly recognize that the child safety seat has been installed in place when the support leg 30 accidentally touches the floor of the vehicle or other objects, and thus improving the correct recognition rate of the alarm device.

FIG. 33 is a schematic view of the alarm device of the child safety seat of the second aspect of the present disclosure. The alarm device 50 may include a body portion 510; a plurality of switches 520a, 520b, 520c electrically connected with the body portion 510, so as to provide the body portion 510 with a signal of whether the switches are turned on or turned off, and the body portion 510 may determine whether to give an alarm based on the signal; an alarm apparatus 530 having light emitting devices 531, 532 and 533 corresponding to the number of switches 520a, 520b and 520c. The body portion 510 may be disposed inside the base 10′. In the embodiment shown in FIG. 33, the plurality of switches 520a, 520b and 520c may be three switches, but it is not limited thereto. The alarm as described above may be an emitted warning (for example, one or more of sound, vibration, light, etc.). In case of an audible warning, a sounding device may be provided in the body portion 510 or the alarm apparatus 530, for example, or may be separately formed in the base 10′. On the other hand, in the case of three switches 520a, 520b and 520c, the three light emitting devices 531, 532 and 533 on the alarm apparatus 530 may correspond to the three switches 520a, 520b and 520c, respectively. Specifically, the light emitting device 531 in the middle corresponds to the switch 520a provided on the first tube 310, and the light emitting devices 532 and 533 on both sides correspond to the switches 520b and 520c on the two anchoring arms 111′ (which will be described in detail below), respectively. The light emitting device may be an LED lamp, for example. Optionally, the plurality of light emitting devices 531, 532, 533 may have different colors. The alarm apparatus 530 may be arranged in the display portion 340, so that the light emitted by the light emitting device may be emitted through an upper surface of the display portion 340. Optionally, the display portion 340 does not have an upper surface and directly exposes the alarm apparatus 530. The body portion 510 may have a logic judging device or an arithmetic device, so as to judge whether or not to give an alarm according to the signals about whether the switches are turned on or turned off received from the switches 520a, 520b and 520c.

The alarm device 50 may be configured to give an alarm when any one of the three switches 520a, 520b and 520c is turned on and they are not all turned on; and give no alarm when all three switches 520a, 520b and 520c are turned on or turned off.

When the alarm device 50 determines to give an alarm, three light emitting devices 531, 532 and 533 on the alarm device 530 indicate the switches 520a, 520b or 520c that are not turned on by emitting light. For example, when the switch 520a provided on the first tube 310 is turned off and the switches 520b and 520c on the two anchoring arms 111′ are both turned on, the light emitting device 531 in the middle emits light, while the light emitting devices 532 and 533 at both sides do not emit light. The light emission may be continuous or flashing.

Optionally, the three light emitting devices 531, 532, 533 on the alarm apparatus 530 may have the opposite logic with respect to the above situations, that is, when the switches 520a, 520b, 520c are turned on, the corresponding light emitting devices emit light. It can be understood that the above logic of the alarm device 50 is equally applicable when there are other numbers of switches and light emitting devices.

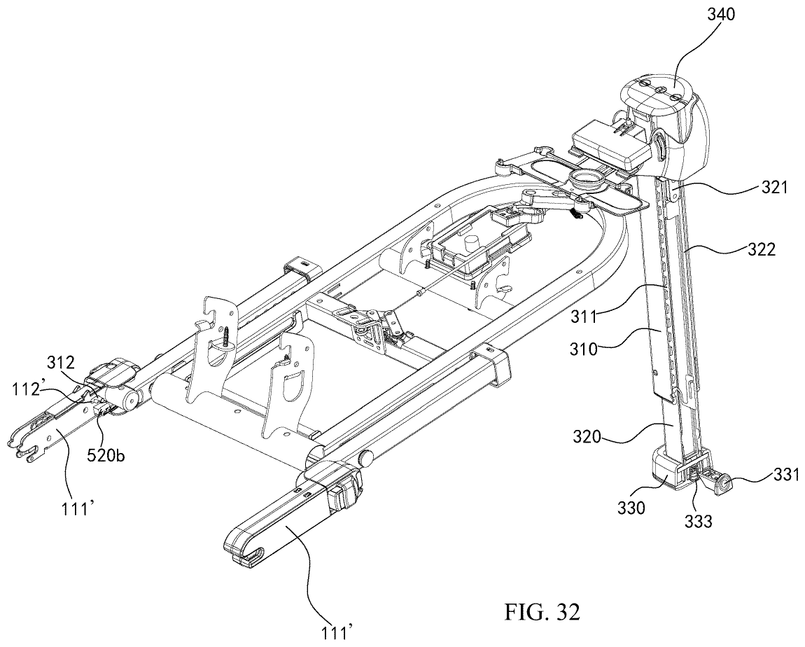

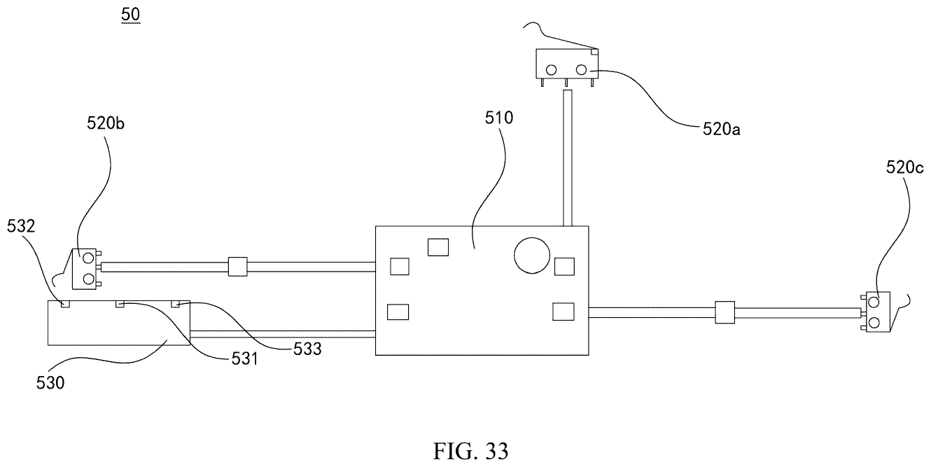

FIG. 31 is a partially sectional perspective view of some components of the child safety seat of the second aspect of the present disclosure, and FIG. 32 is another partially sectional perspective view of some components of the child safety seat of the second aspect of the present disclosure.

A switch 520b/520c may be provided on each of the anchoring arms 111′ (for example, the inner side thereof) (as shown in FIG. 32, the switch 520c is shielded and not shown; it can be understood that the switch 520c is on the other anchoring arm 111′ opposite to the switch 520b, and the switch 520c and the switch 520b face towards each other). The anchoring arm 111′ may also be provided with an elongated hole 112′. A trigger portion 312 is formed in the elongated hole 112′ and may move in the elongated hole 112′. The trigger portion 312 may be fixed at a corresponding position of the base 10′, for example. When the anchoring arm 111′ is engaged with the corresponding interface on the vehicle, the trigger portion 312 moves relative to the elongated hole 112′, while the switch 520b/520c is stationary relative to the elongated hole 112′, so that the trigger portion 312 contacts the switch 520b/520c to turn on the switch 520b/520c. When the anchoring arm 111′ is engaged with the corresponding interface on the vehicle, the trigger portion 312 keeps the corresponding switch 520b/520c turned on. In this way, the switch associated with the anchoring arm 111′ may be turned on to indicate that the anchoring arm 111′ has been fixed in place.

The above-disclosed are merely preferred embodiments of the present disclosure and are intended to limit the scope of the present disclosure, and equivalent variations according to the scope of the present disclosure still fall within the scope of the present disclosure.

1. A safety warning system for a child safety seat having a top tether, an ISOFIX connector and a buckle, wherein the safety warning system for the child safety seat comprises:
an alarm device selectively giving an alarm according to an alarm signal that is received.

2. The safety warning system for the child safety seat according to claim 1, comprising:
a first detection device configured to detect whether the top tether is tensioned and send out a first detection signal when detecting that the top tether is tensioned;
a second detection device configured to detect whether the ISOFIX connector is installed in place and send out a second detection signal when detecting that the ISOFIX connector is installed in place;
a third detection device configured to detect whether the buckle is buckled and send out a third detection signal when detecting that the buckle is buckled; and
a transfer control device configured to receive the first detection signal, the second detection signal and the third detection signal, so that the alarm device sends out an alarm signal when at least one of the first detection signal, the second detection signal and the third detection signal is not received by the transfer control device.

3. The safety warning system for the child safety seat according to claim 2, wherein the first detection device comprises a first detector provided on a moving path of the top tether for detecting whether the top tether is tensioned.

4. The safety warning system for the child safety seat according to claim 2, wherein the second detection device comprises a second detector provided on the ISOFIX connector for detecting whether the ISOFIX connector is installed in place.

5. The safety warning system for the child safety seat according to claim 2, wherein the third detection device comprises a third detector provided on a buckling path of the buckle for detecting whether the buckle is buckled.

6. The safety warning system for the child safety seat according to claim 2, wherein the transfer control device is electrically connected with the first detection device, the second detection device and the third detection device by a wired or wireless mode, respectively.

7. The safety warning system for the child safety seat according to claim 2, wherein the alarm device is electrically connected with the transfer control device.

8. The safety warning system for the child safety seat according to claim 7, wherein the transfer control device and the alarm device are electrically connected with each other by a wired or wireless mode.

9. The safety warning system for the child safety seat according to claim 2, wherein the transfer control device is also communicatively connectable with a mobile terminal or a vehicle control system to send the alarm signal to the mobile terminal or the vehicle control system.

10. The safety warning system for the child safety seat according to claim 2, wherein the transfer control device, the first detection device, the second detection device and the third detection device are provided independently from one another.

11. The safety warning system for the child safety seat according to claim 10, wherein the transfer control device is provided in the child safety seat or a vehicle.

12. The safety warning system for the child safety seat according to claim 10, wherein the first detection device comprises a first detector configured to detect whether the top tether is tensioned, and a first wireless module configured to wirelessly connect with the transfer control device and send the first detection signal to the transfer control device.

13. The safety warning system for the child safety seat according to claim 12, wherein the second detection device comprises a second detector configured to detect whether the ISOFIX connector is installed in place, and a second wireless module configured to wirelessly connect with the transfer control device and send the second detection signal to the transfer control device.

14. The safety warning system for the child safety seat according to claim 13, wherein the third detection device comprises a third detector configured to detect whether the buckle is buckled, and a third wireless module configured to wirelessly connect with the transfer control device and send the third detection signal to the transfer control device.

15. The safety warning system for the child safety seat according to claim 14, wherein the transfer control device comprises a wireless communication module configured to wirelessly connect with the first wireless module, the second wireless module and the third wireless module.

16. The safety warning system for the child safety seat according to claim 15, wherein the wireless communication module, the first wireless module, the second wireless module and the third wireless module are Bluetooth modules or Wi-Fi modules.

17. The safety warning system for the child safety seat according to claim 10, wherein the first detection device comprises a first detection circuit board and a first detector electrically connected to the first detection circuit board; the second detection device comprises a second detection circuit board and a second detector electrically connected to the second detection circuit board; the third detection device comprises a third detection circuit board and a third detector electrically connected to the third detection circuit board; and the first detection circuit board, the second detection circuit board and the third detection circuit board are respectively electrically connected to the transfer control device through wires.

18. The safety warning system for the child safety seat according to claim 6, wherein the transfer control device is integrated with the first detection device, the second detection device and the third detection device; the first detection device comprises a first detector provided on the moving path of the top tether for detecting whether the top tether is tensioned, and the first detector is electrically connected to the first detection device through wires; the second detection device comprises a second detector provided on the ISOFIX connector for detecting whether the ISOFIX connector is installed in place, and the second detector is electrically connected to the second detection device through wires; the third detection device comprises a third detector provided on the buckling path of the buckle for detecting whether the buckle is buckled, and the third detector is electrically connected to the third detection device through wires.

19. The safety warning system for the child safety seat according to claim 14, wherein when the top tether is tensioned, it acts on the first detector, so that the first detection device generates and sends out the first detection signal.

20. The safety warning system for the child safety seat according to claim 19, wherein the first detection device further comprises a first trigger, the first trigger is movably provided and connected to the top tether, and is driven to move during the tension process of the top tether to act on the first detector.

21. The safety warning system for the child safety seat according to claim 20, wherein the first detection device further comprises an elastic member abutting against the first trigger, and when the top tether is not tensioned, an elastic force of the elastic member resets the first trigger to release the first detector.

22. The safety warning system for the child safety seat according to claim 20, wherein the first detection device further comprises a traction member, two ends of the traction member are respectively connected to the top tether and the first trigger, and the top tether pulls the first trigger to move via the traction member.

23. The safety warning system for the child safety seat according to claim 22, wherein the first detection device further comprises a slider slidably provided and connected with the top tether and the traction member respectively, and when the top tether is tensioned by an external force, the slider is driven to slide, and pulls the first trigger to move via the traction member.

24. The safety warning system for the child safety seat according to claim 14, wherein the second detection device further comprises a second trigger movably provided and connected to the ISOFIX connector, and the second trigger is driven to move during installation of the ISOFIX connector to act on the second detection device, and when the ISOFIX connector is installed in place, the second detection device generates and sends out the second detection signal.

25. The safety warning system for the child safety seat according to claim 14, wherein the third detector is installed in a male buckle or a female buckle of the buckle, and when the male buckle is buckled with the female buckle, the male buckle or female buckle acts on the third detector, and the third detection device generates and sends out the third detection signal.

26. The safety warning system for the child safety seat according to claim 25, wherein a through hole is provided on one of the male buckle and the female buckle, the third detector is disposed inside the male buckle or the female buckle and protrudes through the through hole on an insertion path between the male buckle and the female buckle, and the male buckle or female buckle acts on the third detector when the male buckle is buckled with the female buckle.

27. The safety warning system for the child safety seat according to claim 14, wherein each of the first detector, the second detector and the third detector is any one of a mechanical switch, a contact sensor, a pressure sensor, an infrared sensor and a displacement sensor.

28. A child safety seat adapted to be installed on a seat of a vehicle, wherein comprises the safety warning system for the child safety seat according to claim 1.

29. The child safety seat according to claim 28, wherein the child safety seat comprises:
a base having an anchoring portion connected to the seat of the vehicle;
a seat portion arranged on the base; and
a support leg arranged at a front of the base and extending from the base towards a floor of the vehicle;
wherein the alarm device comprises a plurality of switches, and selectively giving an alarm in response to turning-off and turning-on of the plurality of switches,
wherein the support leg comprises a first tube and a second tube sleeved with each other, and when the first tube is locked to the second tube, a pressure is applied to an end of the second tube to turn on one of the plurality of switches.

30. The child safety seat according to claim 29, wherein the plurality of switches are three switches, and the alarm device is configured to:
give an alarm when any one of the three switches is turned on and the three switches are not all turned on; and
give no alarm when all the three switches are turned on or turned off.

31. The child safety seat according to claim 30, wherein the anchoring portion comprises two anchoring arms, a first switch in the three switches is turned on in response to the support leg abutting against the floor of the vehicle, and the second switch and the third switch in the three switches are turned on in response to a corresponding one of the two anchoring arms being anchored to a position of the seat of the vehicle, respectively.

32. The child safety seat according to claim 31, wherein the support leg comprises a display portion having three light emitting devices sequentially arranged along a transverse direction of the child safety seat, when the alarm device gives an alarm, an light emitting device in the middle in the three light emitting devices emits light in response to turning-on of the first switch, and light emitting devices on both sides in the three light emitting devices emit light in response to turning-on of the first switch and the second switch, respectively.

33. The child safety seat according to claim 29, wherein a receiving member is arranged in the first tube, the receiving member is slidably arranged between the first tube and the second tube, and an end of the receiving member is provided with a trigger portion for turning-on one of the plurality of switches.

34. The child safety seat according to claim 33, wherein the first tube is slidably sleeved on the second tube, and an engaging member is arranged in the second tube and is selectively locked to different positions of the receiving member.

35. The child safety seat according to claim 34, wherein the support leg further comprises a grounding portion at an end of the second tube for contacting the floor of the vehicle, the grounding portion comprises pressing portions arranged at both sides, and the pressing portions are linked with the engaging member, so that when the pressing portions are pressed, the engaging portion is disengaged and unlocked with the receiving member, and when the pressing portions are not pressed, the engaging portion is locked with the receiving member.

36. The child safety seat according to claim 35, wherein the second tube further comprises a linkage, the pressing portions and the engaging portion are linked through the linkage, a first inclined surface is formed on the pressing portion, and a second inclined surface is formed on an end of the linkage, and movement of the pressing portions in a first direction enables the linkage to move in a second direction perpendicular to the first direction via cooperation of the first inclined surface and the second inclined surface.

37. The child safety seat according to claim 36, wherein the engaging member is rotatably fixed in the second tube via a pivot shaft, a chute is formed on the other end of the linkage, the engaging member is coupled with the chute via an actuating shaft, the actuating shaft is movable in the chute, and movement of the linkage in the second direction enables the engaging member to rotate about the pivot shaft.

38. The child safety seat according to claim 36, wherein an elongated slot extending in the second direction is formed on the linkage, a pin fixed in the second tube passes through the elongated slot, and a reset member is arranged between the linkage and the grounding portion to provide a thrust force.

39. The child safety seat according to claim 33, wherein the receiving member is provided with a plurality of segment holes along a direction in which the first tube moves relative to the second tube, and the engaging member is locked to the receiving member by engaging with one of the plurality of segment holes.
